(19) United States
(12) Patent Application Publication
(10) Pub. No.: US 2018/0196665 A1
(43) Pub. Date: Jul. 12, 2018

(54) MANAGING, USING, AND UPDATING APPLICATION RESOURCES

(71) Applicant: Alibaba Group Holding Limited, George Town (KY)

(72) Inventors: Zhongxiao Yao, Hangzhou (CN); Xianghong Jia, Hangzhou (CN); Tao Yang, Hangzhou (CN); Xiandong Huang, Hangzhou (CN); Ping Dong, Hangzhou (CN); Yongsheng Zhu, Hangzhou (CN); Xiaojing Xu, Hangzhou (CN)

(21) Appl. No.: 15/864,643

(22) Filed: Jan. 8, 2018

(30) Foreign Application Priority Data
Jan. 9, 2017 (CN) 201710014625.7

(51) Int. Cl. G06F 8/71; G06F 8/20

(52) U.S. Cl. CPC G06F 8/71; G06F 8/20

(57) ABSTRACT

Embodiments of the present application relate to a method, device, and system for managing, using, and updating application resources. A method includes obtaining, by one or more processors, an application development kit, wherein the application development kit comprises resources for one or more application components, obtaining, by the one or more processors, the resources for at least one of the one or more application component resources included in the application development kit, packaging, by the one or more processors, at least one or more application component resources to obtain one or more application resource kits, wherein a unit of resources organization for the one or more application resource kits is the one or more application components, and providing the one or more application resource kits to a client device in response to obtaining a request for the one or more application resource kits.

### CROSS REFERENCE TO OTHER APPLICATIONS

This application claims priority to People's Republic of China Patent Application No. 201710014625.7 entitled A METHOD FOR MANAGING APPLICATION RESOURCES, A METHOD USING THEM AND MEANS FOR SAME filed Jan. 9, 2017, which is incorporated herein by reference for all purposes.

### FIELD OF THE INVENTION

The present application relates to a field of computer technology. In particular, the present application relates to a method, device, and system for managing application resources and using application resources.

### BACKGROUND OF THE INVENTION

With the rapid development of mobile telecommunication technology and the arrival of the mobile multimedia age, the mobile phone, which is a necessary tool of mobile telecommunication, has developed from a simple telecommunication tool to a smart terminal with various functionality. The mobile phone has evolved into a mobile platform for collecting and processing personal information. The mobile terminal is developed into a smart phone via the use of operating systems and a wide array of application software.

According to current technology, smart phone-based application programs (also referred to herein as applications) need to be installed on smart phones before smart phones can be used. However, many applications actually are only needed or used in particular contexts. For example, the user may not use an application regularly or for a long period of time; or a user may not use a particular functionality of an application regularly or for a long period of time. In addition, when a user makes use of an application, the user might use only some of the functions therein. The other functions of an application may never be used. Nevertheless, the applications are installed on a smart phone and such applications generally use a large volume of memory resources.

Therefore, a problem that currently confronts the telecommunications and mobile terminal industry is the need for development of applications that are more lightweight, more user friendly, and more efficient with respect to memory resources.

### BRIEF DESCRIPTION OF THE DRAWINGS

Various embodiments of the invention are disclosed in the following detailed description and the accompanying drawings.

In order to provide a clearer explanation of the technical schemes in embodiments of the present application, simple introductions are given below to the drawings that are needed for the embodiments. Obviously, the drawings described below are merely some embodiments of the present application. Persons with ordinary skill in the art could, without expending creative effort, obtain other drawings on the basis of these drawings.

FIG. 1 is an architectural diagram of a system according to various embodiments of the present disclosure.

FIG. 2 is an architectural diagram of an application development kit directory according to various embodiments of the present disclosure.

FIG. 3 is a structural diagram of a server according to various embodiments of the present disclosure.

FIG. 4 is a flowchart of a method for application resource management according to various embodiments of the present disclosure.

FIG. 5 is a structural diagram of a client device according to various embodiments of the present disclosure.

FIG. 6 is a structural diagram of a server according to various embodiments of the present disclosure.

FIG. 7 is a flowchart of a method for using an application resource according to various embodiments of the present disclosure.

FIG. 8 is a flowchart of a method for using an application resource according to various embodiments of the present disclosure.

FIG. 9 is a flowchart of a method for using an application resource according to various embodiments of the present disclosure.

FIG. 10A is a diagram of updating an application resource according to various embodiments of the present disclosure.

FIG. 10B is a diagram of updating an application resource according to various embodiments of the present disclosure.

FIG. 10C is a diagram of a method for updating an application resource according to various embodiments of the present disclosure.

FIG. 11 is a diagram of a User Interface (UI) of application components according to various embodiments of the present disclosure.

FIG. 12 is a diagram of a UI of application components according to various embodiments of the present disclosure.

FIG. 13 is a diagram of a UI of application components according to various embodiments of the present disclosure.

FIG. 14 is a functional diagram of a computer system updating, using, or managing application resources according to various embodiments of the present disclosure.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Although the concepts of the present application may easily undergo various modifications and substitutions, its specific embodiments have already been shown through the examples in the drawings and in the detailed descriptions in this document. However, please note that there is no intention of limiting the concepts of the present application to the disclosed specific forms. On the contrary, the intention is to cover all modifications, equivalents, and substitutions consistent with the present application and the attached claims.

In citing “an embodiment,” “the embodiments,” “an illustrative embodiment,” etc., the Description is indicating that the described embodiment may include specific features, structures, or characteristics. However, each embodiment may or may not include particular features, structures, or characteristics. In addition, such phrases do not necessarily refer to the same embodiments. Furthermore, it is believed that, when the features, structures, or characteristics are described in light of embodiments, such features, structures, or characteristics are affected through their combination with other embodiments (whether they are described clearly) within the scope of knowledge of persons skilled in the art. In addition, please understand that the items included in a list taking the form of “at least one of A, B and C” may be expressed as: (A), (B), (C), (A and B), (A and C), (B and C), or (A, B and C). Similarly, items listed in the form of “at least one of A, B or C” may be expressed as: (A), (B), (C), (A and B), (A and C), (B and C), or (A, B and C).

In some cases, the disclosed embodiment may be implemented as hardware, firmware, software, or any combination thereof. The disclosed embodiment may also be implemented as instructions that are carried or stored in one or more temporary or non-temporary machine-readable (e.g., computer-readable) storage media that can be read and executed by one or more processors. Machine-readable storage media may be embodied as any storage device, mechanism, or other device with physical structures used to store or transmit information in machine-readable form (such as volatile or non-volatile memory, media disks, or other media).

In the drawings, some structures or method features may be shown in specific layouts and/or sequences. However, please understand that these specific layouts and/or sequences may be unnecessary. On the contrary, in some embodiments, these features may be laid out in ways and/or sequences that differ from what is shown in the illustrative drawings. In addition, the fact that a particular drawing includes structure or method features does not imply that such features are necessary in all embodiments. Moreover, in some embodiments, they may not be included, or they may be combined with other features.

As used herein, a terminal generally refers to a device used (e.g., by a user) within a network system and used to communicate with one or more servers. According to various embodiments of the present disclosure, a terminal includes components that support communication functionality. For example, a terminal can be a smart phone, a tablet device, a mobile phone, a video phone, an e-book reader, a desktop computer, a laptop computer, a netbook computer, a personal computer, a Personal Digital Assistant (PDA), a Portable Multimedia Player (PMP), an mp3 player, a mobile medical device, a camera, a wearable device (e.g., a Head-Mounted Device (HMD), electronic clothes, electronic braces, an electronic necklace, an electronic accessory, an electronic tattoo, or a smart watch), a smart home appliance, vehicle-mounted mobile stations, or the like. A terminal can run various operating systems.

In an embodiment of the present application, a “smart terminal” is a terminal device having multimedia functions. A smart terminal supports audio, video, data, and other such functions. The smart terminal can have a touchscreen. The smart terminal can correspond to a smart mobile device such as a smart phone, a tablet computer, or a smart wearable device, or a smart television, personal computer, or other such device with a touchscreen. Various operating systems such as Android, iOS, YunOS, and tvOS can be implemented on the smart terminal. Various embodiments discussed herein are in the context of the example of a television device using tvOS; however, other types of terminals or operating systems can be used.

Various embodiments enable users to use application program functions without having to install a new application program. According to various embodiments, users are not required to download and install application programs. Users can use application components as needed, and users do not have to install the application. Terminal memory resource expenditures are thus reduced. Various embodiments can be implemented in connection with various operating systems. For example, various embodiments can be implemented in connection with a mobile operating system (e.g., Android™, iOS™, etc.), a cloud operating system (YunOS™) etc.

Various embodiments relate to the management of application resources and the use of application resources. Application resource management includes application resource publishing management. The application resource publication management includes a server handling application development kit developed and/or uploaded by developers. Application resource management includes storing, indexing, and otherwise managing application resources. As an example, the unit of resources organization is application component. For example, resources can be organized or managed on an application component-by-application component basis. Application resource use includes the obtaining and running of application resources. For example, the use of application resources can include the client device (e.g., a terminal) acquiring one or more application resources. An application resource can refer to an application component. Accordingly, the use of application resources can include the obtaining and running of one or more application components.

“Application development kits” refer to data structures developed by application developers and packaged according to set rules. An application development kit can comprise resources of one or more application components. An application development kit can further comprise configuration information for describing and defining application components. The configuration information can include a component name, a tile, an icon, a function entry, a data and resource security level, etc.

“Application components” refer to data and function set (such as libraries). The data and function set can include code, an icon, a text file, an html file, etc. The data and function set is used to describe and provide actual service or logical functions. Application components can implement certain functions (e.g., play music, play video, display images, etc.). An application program generally includes multiple application components. The various application components work together and jointly form the functions of a complete application program. In other words, application components are execution units that have a smaller granularity than applications. Application components typically have less code than applications. As an example, an application component, as compared with an application, have smaller downloading size, downloading time, response time from selection to display, etc. An application component can be executed in another application or executed by itself.

To take the example of a cloud operating system, an application component in a cloud operating system could be defined as a Page. A “Page” can refer to a basic unit that provides local or remote service. For example, a Page is an abstraction of local service and/or remote service. A Page can be the basic unit of service. By packaging data and methods, the packaged data and function set can provide various kinds of services. A running Page is called a Page instance. A Page instance can be the running carrier for local service or remote service. A Page can be uniquely identified on a cloud operating system. For example, a Page can be identified using a Uniform Resource Identifier (URI). As an example, a Page is a component of an application and includes a data and function set. A Page can be run or executed by invoking a method that executes the Page or API provided by the operating system. An operating system can executed the code or render the Page directly.

Application component resources include, but are not limited to, one or a combination of the following: application component program code files (e.g., application component program code compiled as executable files) and resources used by application components. Resources used by application components can be organized in the form of files. As an example, resources used by application components include, but are not limited to, one or more kinds of files: files for describing dependency relationships between application components, and data resource files used by application components, such as picture files, video files, audio files, and text files. As an example, an application component includes one or more application component resources and one or more application component functions. The application component can be the basic logical executable (or runnable) unit. As an example, an application component resources is a static resource such has a file or an icon.

Configuration information for describing application components can be organized in the form of files. For example, configuration information for describing application components can include application component configuration files and signature files. As an example, an application component configuration file includes a manifest.json that defines one or more of a component name, a tile, an icon, a uniform resource identifier, etc. As an example, the signature files include one or more of a developer certificate, a package integrity check value, etc. The signature files can be used for a developer certification check and a package integrity check. Application component configuration files can be used in connection with (e.g., used for) declaring the relevant application components included in application development kits. The application component configuration files can also have configuration information. As an example, an application component configuration file comprises the basic information of application components in an operating system (e.g., title, identifier, version, etc.). An application component configuration file can comprise other configuration information on application components, such as an indication of whether the data of an application component is stored on the network side (such as a cloud), an indication of whether hardware acceleration is permissible, etc. According to various embodiments, one application development kit contains one application component configuration file. The signature file can comprise relevant signature information, such as the developer's identity information. The signature file can be used in connection with information-encrypting digital signatures.

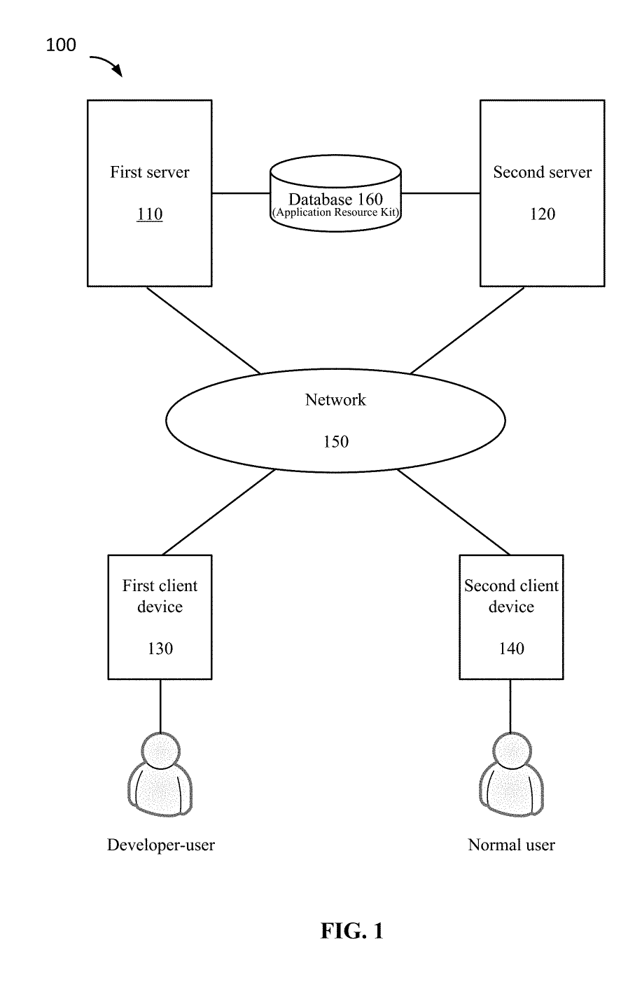

FIG. 1 is an architectural diagram of a system according to various embodiments of the present disclosure.

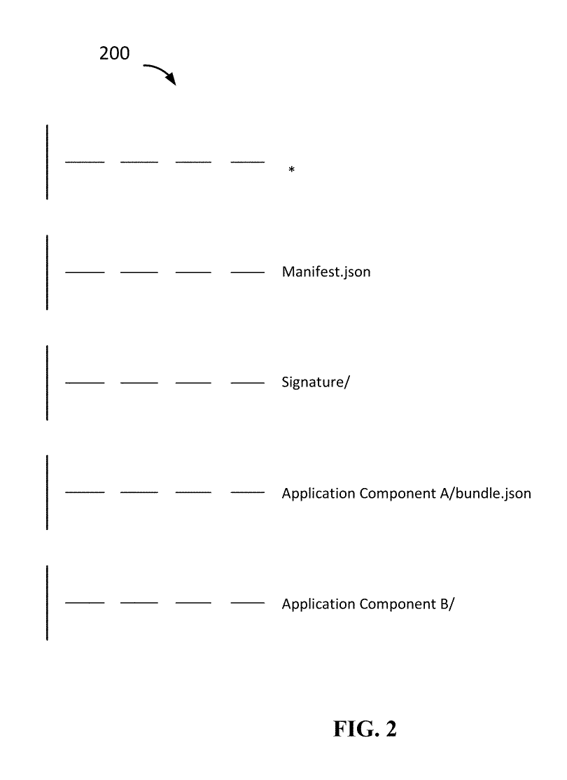

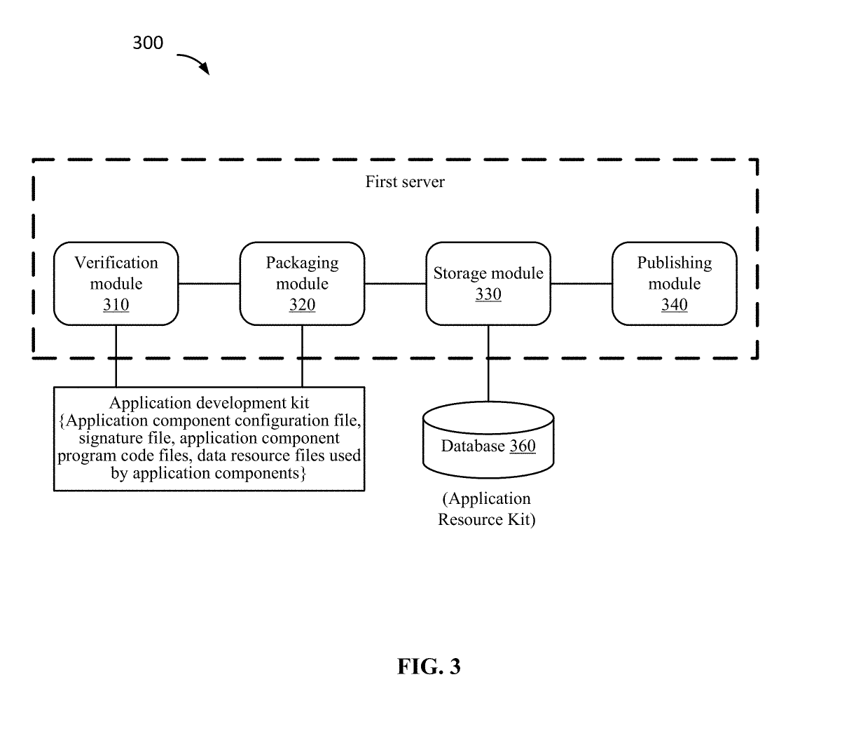

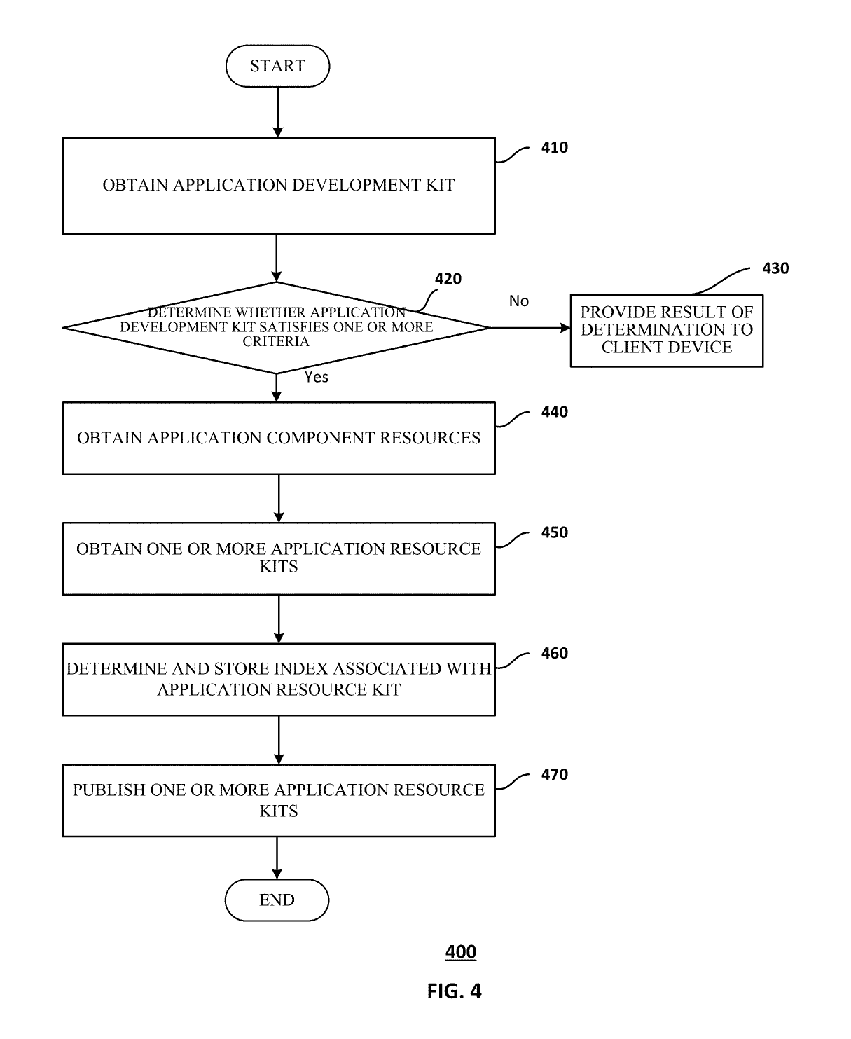

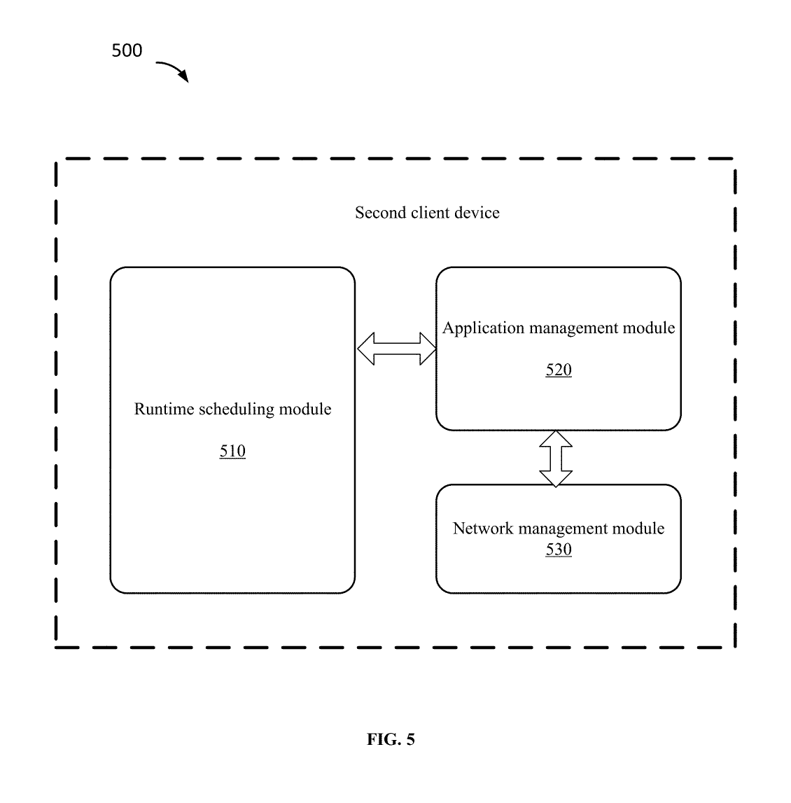

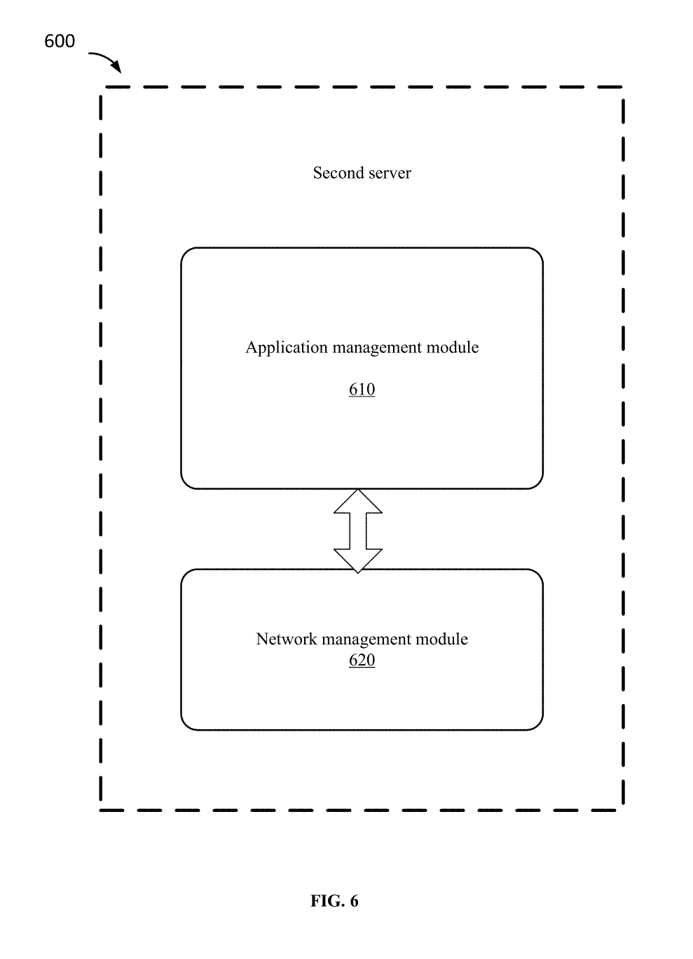

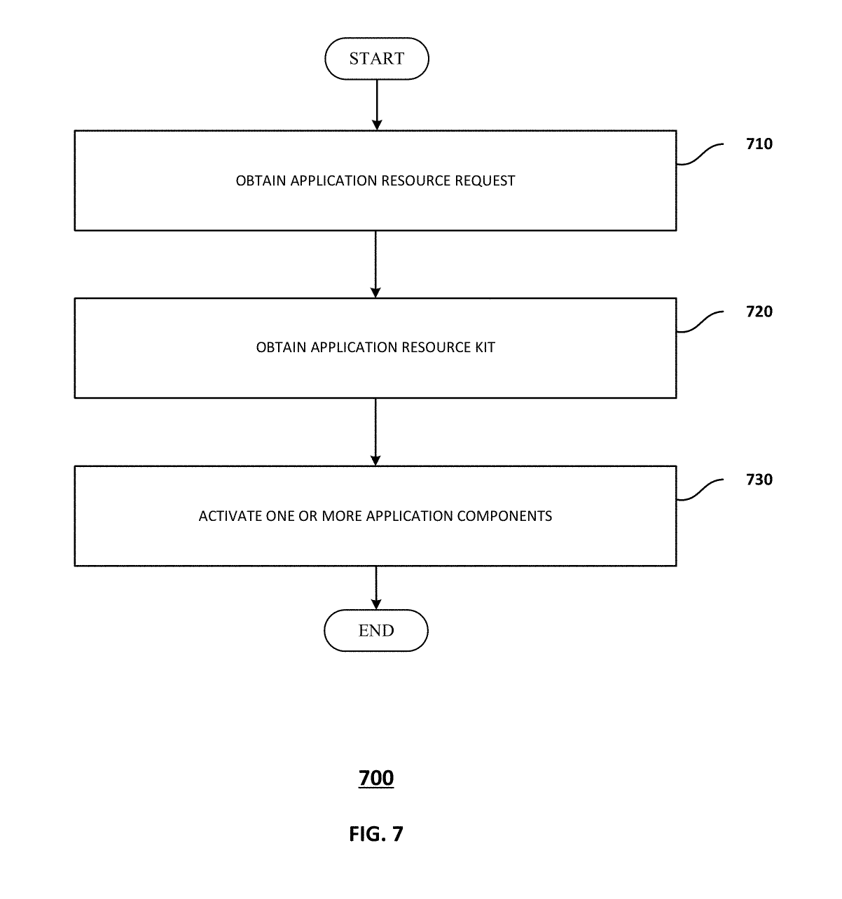

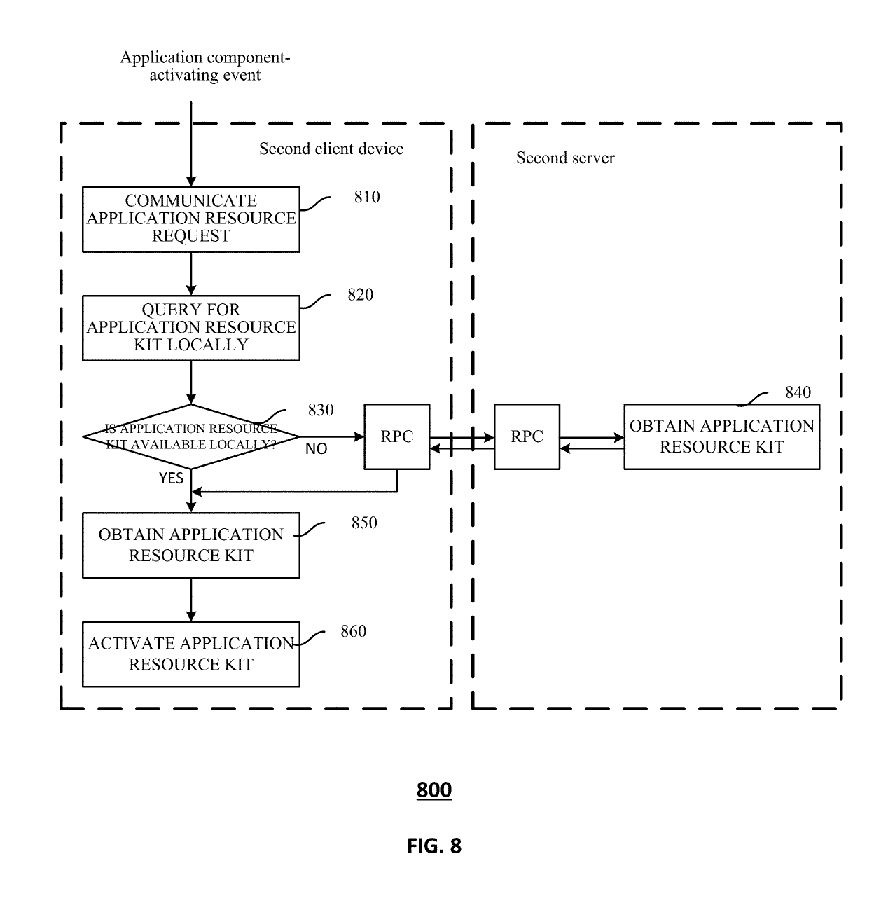

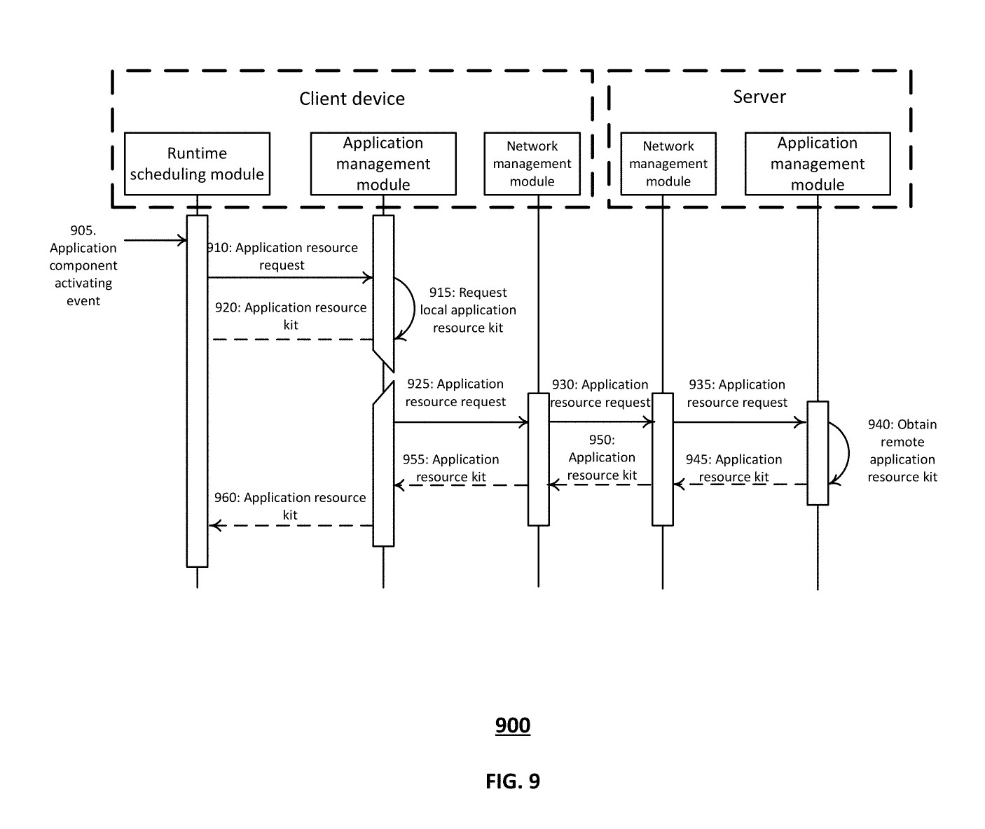

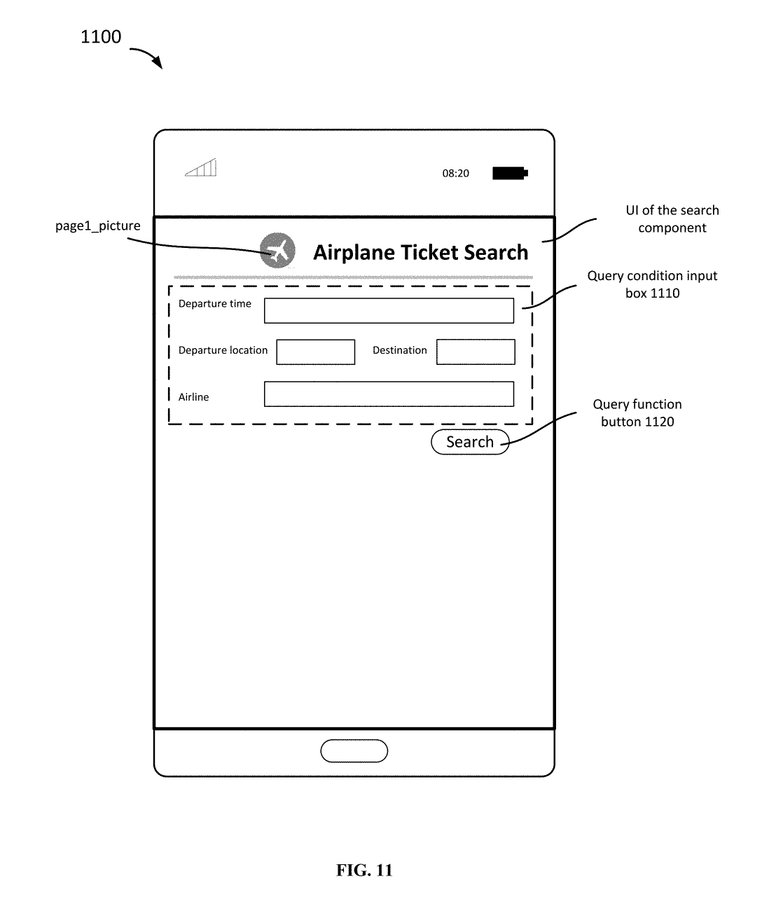

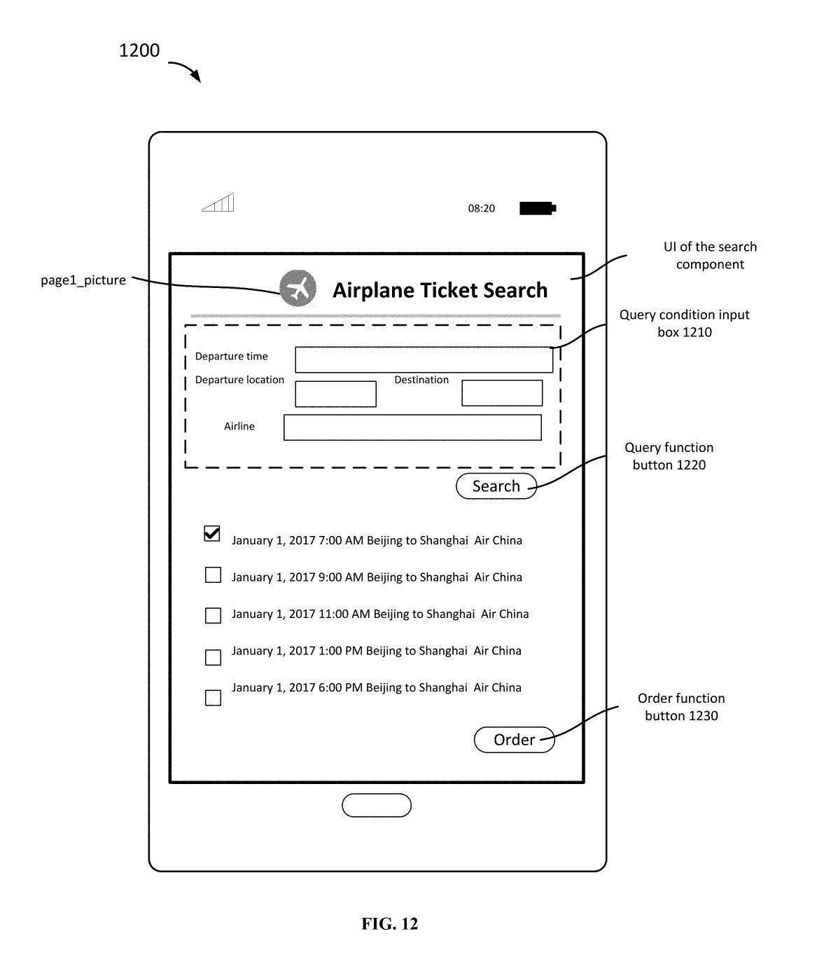

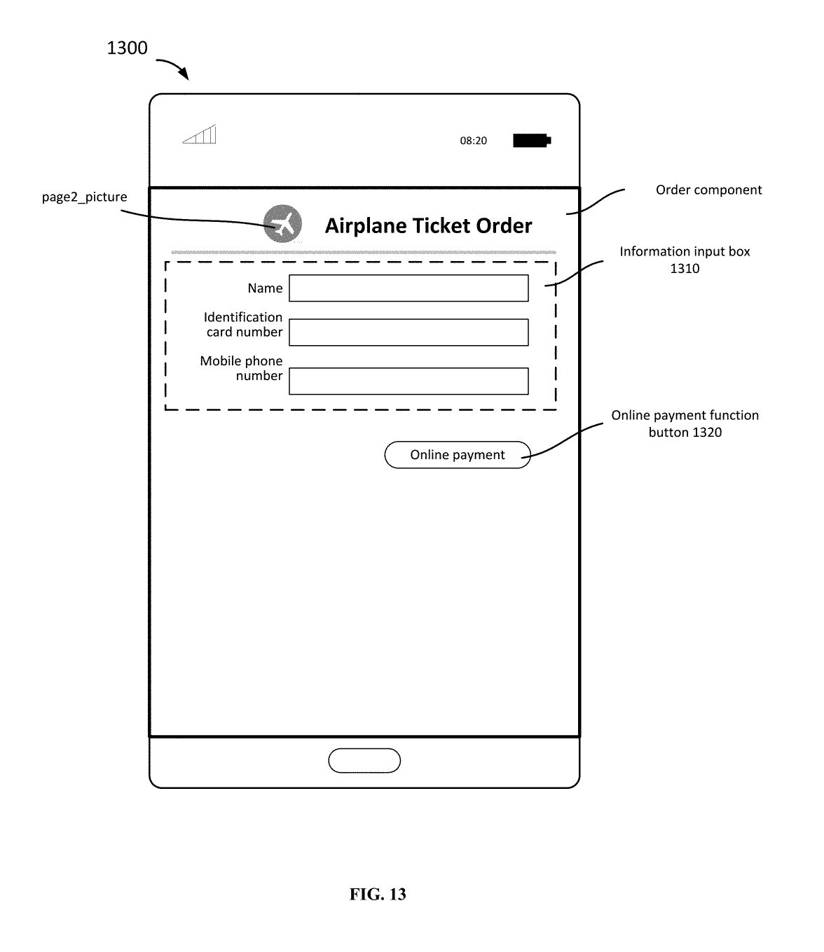

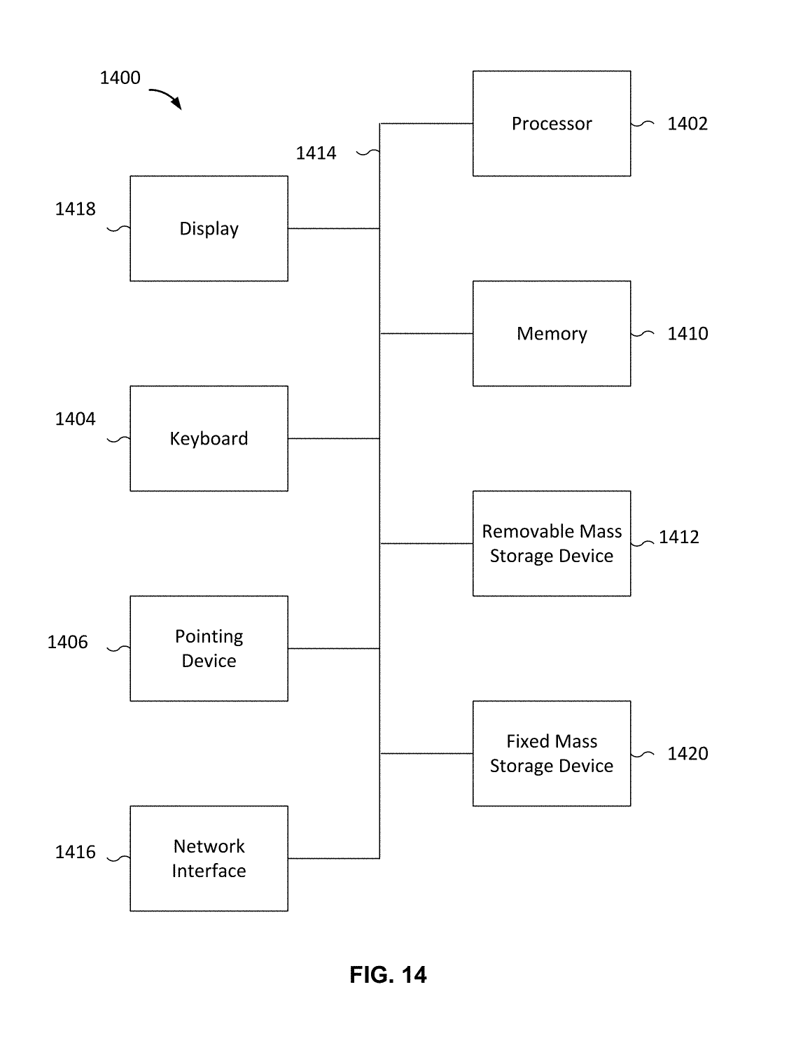

Referring to FIG. 1, system 100 is provided. System 100 can be implemented in connection with application development kit directory 200 of FIG. 2, user interface 1100 of FIG. 11, user interface 1200 of FIG. 12, and/or user interface 1300 of FIG. 13. System 100 can implement at least part of process 400 of FIG. 4, process 700 of FIG. 7, process 800 of FIG. 8, and/or process 900 of FIG. 9. At least part of system 100 can be implemented by server 300 of FIG. 3, device 500 of FIG. 5, server 600 of FIG. 6, and/or computer system 1400 of FIG. 14.

As illustrated in FIG. 1, system 100 comprises a first server 110, a second server 120, a first client device 130, and a second client device 140. The first server 110, the second server 120, the first client device 130, and the second client device 140 can be connected via one or networks such as network 150 and communicated based on the network 150. Network 150 can be a wide area network, a local area network, the Internet, etc.

According to various embodiments, system 100 comprises database 160. Database 160 can store one or more application resource kits. Database 160 is a local repository or a remote repository that is connected to one or more of the first server 110 and the second server 120. As an example, database 160 can be a cloud storage (e.g., a repository that is accessible via a network).

First client device 130 and/or second client device 140 can be terminals. For example, first client device 130 and/or second client device 140 can be smart terminals.

Although FIG. 1 shows only a first client device 130 and a second client device 140, system 100 can comprise a plurality of client devices. System 100 can comprise various devices (e.g., terminals). For example, system 100 can comprise any appropriate computing or mobile device, and may include: smart phones, tablet computers, notebook computers, personal digital assistants (PDAs), smart wearable devices, or similar devices. Client devices comprised in system 100 can use a cloud operating system or another operating system. Embodiments of the present application do not impose restrictions in this regard.

Although FIG. 1 shows only a first server 110 and a second server 120, system 100 can comprise a plurality of servers. System 100 can comprise various servers and various types of servers. In some embodiments, system 100 comprises a single server that performs the functions of the first server 110 and the second server 120.

As illustrated in FIG. 1, system 100 comprises first client device 130, which can correspond to a terminal that is associated with, or otherwise, operated by, a developer-user (also referred to herein as a developer). A developer can be a person or organization that develops applications (e.g., application programs), etc. A user who is a developer may communicate an application development kit via client device 130 to a first server 110. Client device 130 can communicate the application development kit to the first server 110 over network 150. First server 110 can store the application development kit in association with the developer (e.g., an identifier associated with the developer). First server 110 can store the application development kit or one or more parts obtained from the application development kit.

First client device 130 can comprise an application development module. First client device 130 can use the application development module in connection with developing an application, an application component, etc. For example, the developer-user can use the application development module to develop application components and to package the application components according to set rules as an application development kit. First client device 130 can generate the application development kit based at least in part on one or more application components. As an example, the application development kit is generated by a zip files to an archive and then generating a developer certificate and integrity value for the archive. First client device 130 can generate the application development kit in a manner that packages the one or more application components. For example, the unit of resource organization of the application development kit can be an application component.

The first server 110 can obtain the application development kit. For example, first server 110 can receive the application development kit from first client device 130 via network 150. After receiving the application development kit (e.g., sent by first client device 130), first server 110 can split the application development kit into the application component resources included in the application development kit. For example, first server 110 can parse the application development kit to obtain one or more constituent parts of the application development kit. First server 110 can parse the application development kit and obtain one or more application component resources comprised in the application development kit. First server 110 re-packages the one or more application component resources comprised in the application development kit so that the application component is the unit of resource organization, and, moreover, indexes and stores these application development kit. In some embodiments, the application resources (e.g., application components) are be stored in the database 160.

Second client device 140 can obtain the application development kit from a server (or directly from database 160). For example, second client device 140 can request the application development kit (e.g., or another application component or application resource) from a server via the network, the server can obtain the application development kit (e.g., or another application component or application resource) responsive to the request obtained from the second client device 140, and the server communicates the application development kit (e.g., or another application component or application resource) to the second client device 140. In system 100, a normal user can request an application development kit via the second client device 140 and locally run the application component of the acquired application development kit on the second client device 140. During the process of obtaining an application resource kit, the second client device 140 can send an application development request to a server (e.g., the second server 120). The second server 120 can use this application resource request as a basis for obtaining the requested application development kit from the database 160, and can send the acquired application development kit to second client device 140. Second server 120 can query database 160 based at least in part on the application resource request.

According to various embodiments, the application development kit is packaged in accordance with set rules. The set rules can be predefined by one or more users such as an administrator. The rules with which the application development kit is packaged can be used in connection with the application resource management. For example, after obtaining (e.g., in response to obtaining) the application development kit packaged in accordance with the set rules, the first server 110 can conduct application resource management with respect to one or more application resources (e.g., one or more application components) that are comprised in the application development kit. If the application development kit obtained by the first server 110 was not packaged in accordance with set rules, the first server 110 can manage the application resources (e.g., conduct application resource management) in another manner.

The application development kit packaging rules can be established in a manner such that the application component configuration file and one or more application components are in a same-level directory within a file system. As an example, the same level directory refers to the directory for each application component have the same path (e.g., path length) to the application development kit. For example, the application components have their own sub-directory and the application development kit corresponds to the root directory. An integrated development environment can check the path length during packaging for the project. The program code files (e.g., compiled, executable files) of an application component (e.g., each application component) can be included under an application component directory. The data resource files (e.g., picture files, etc.) used by the application component can be included in the application component directory under which the application component is included. If the running of an application component also relies on one or more other application components, then the directory for the application component can include a file for describing (or otherwise indicating) the dependency relationships of the one or more other application components. In some embodiments, data files that are shared by multiple application components are included in same-level directories with the application component configuration files, signature files, and application components. As an example, shared data files are placed in a common directory having a same-level with the application components and the application components can use the common directory. The shared data files can correspond to files that are used by a plurality of application components.

FIG. 2 is an architectural diagram of an application development kit directory according to various embodiments of the present disclosure.

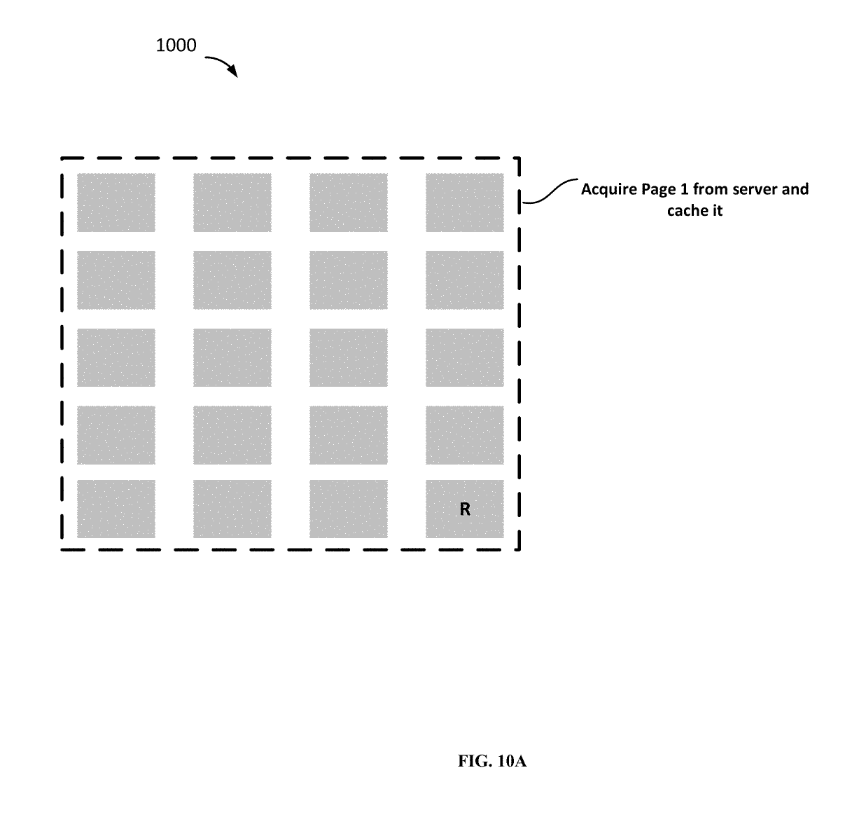

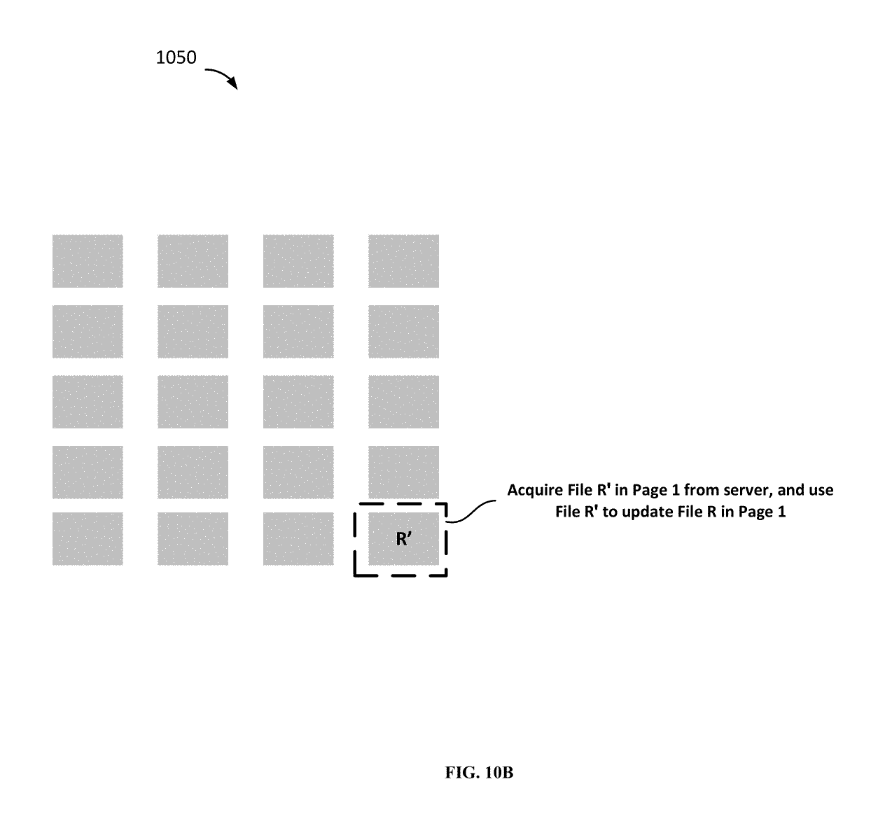

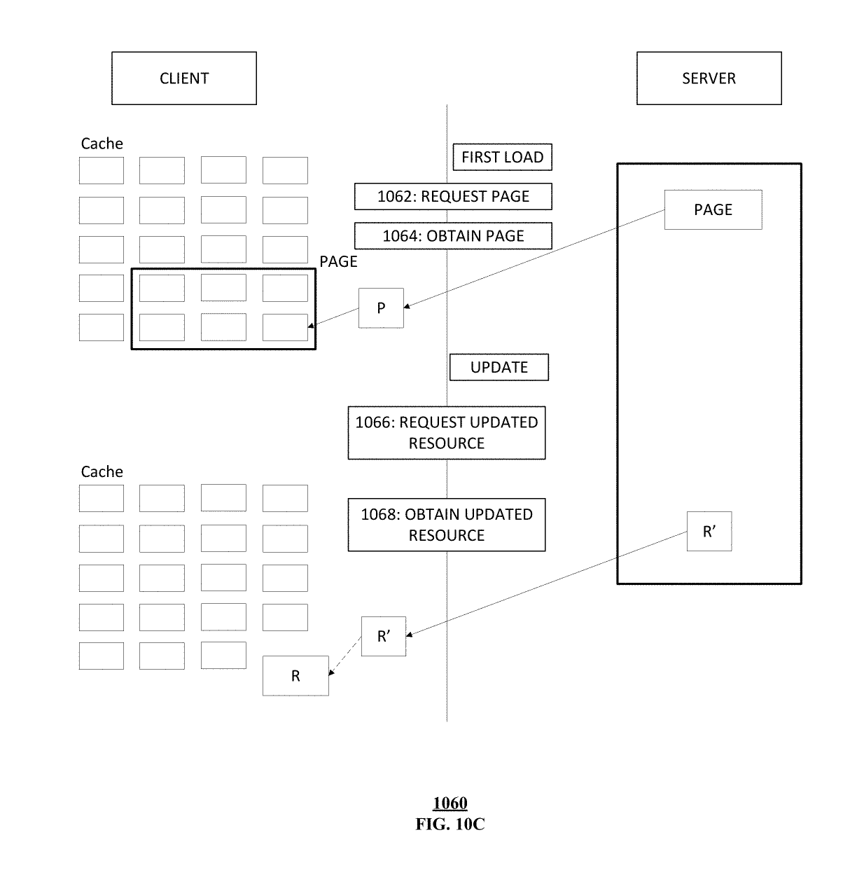

Referring to FIG. 2, an application development kit directory 200 is provided. The application development kit directory 200 can be used in connection with an application development kit. For example, application development kit directory 200 can be used to describe a structure of an application development kit. Application development kit directory 200 can be implemented in connection with system 100 of FIG. 1, server 300 of FIG. 3, process 400 of FIG. 4, device 500 of FIG. 5, server 600 of FIG. 6, process 700 of FIG. 7, process 800 of FIG. 8, process 900 of FIG. 9, application development kit 1000 of FIG. 10A, application development kit 1050 of FIG. 10B, user interface 1100 of FIG. 11, user interface 1200 of FIG. 12, and/or computer system 1400 of FIG. 14.

As indicated above, FIG. 2 provides an example of an application development kit directory 200. For the purpose of providing an example, only a core directory result is provided. “Manifest” refers to a file name of an application component configuration file. The application component configuration file can use JSON data format. Other file formats can be used or implemented in connection with the configuration file. The application component configuration file declares Application Component A and Application Component B. Application Component A and Application Component B are component names defined in the Manifest file. The application component names and the directory names are kept the same. The application components and directory names can be kept the same to facilitate repackaging the application development kit according to the application component root directory (e.g., the directory that has the same name with the application component names). Under each application component directory are saved the program code files and resource files (e.g., picture files used by the application component) related to the corresponding application component. A file (e.g., as illustrated in FIG. 2, bundle.json) for describing dependency relationships (e.g., among application components) is also included under the Application Component A directory. The file for describing dependency relationships is used to define the dependence of Application Component A on external resources. For example, if Application Component A is dependent on resources defined by “common,” then this dependency relationship is explicitly defined in the bundle.json file. A signature file (not shown) is included under the Signature directory.

As an example, directory 200 illustrates the component level directory and illustrates core directory or files. Directory 200 (or sub-directories thereof) can include other directories or files.

Directory 200 is used to illustrate an example of a directory organization that requires components and core files that are included in the same level. The directory organization can correspond to developer rules for resource (e.g., files) organization. Directory 200 can include manifest.json, signature, Application Component A and Application Component B.

The directory structure shown by FIG. 2 is merely an example. Embodiments of the present application impose no restrictions in this regard.

The application resource management process provided by embodiments of the present application is described in detail below in connection with FIGS. 3 and 4.

FIG. 3 is a structural diagram of a server according to various embodiments of the present disclosure.

Referring to FIG. 3, server 300 is provided. Server 300 can be used in connection with system 100 of FIG. 1. Server 300 can be implemented in connection with application development kit directory 200 of FIG. 2, user interface 1100 of FIG. 11, user interface 1200 of FIG. 12, and/or user interface 1300 of FIG. 13. Server 300 can implement at least part of process 400 of FIG. 4, process 700 of FIG. 7, process 800 of FIG. 8, and/or process 900 of FIG. 9. Server 300 can be implemented by computer system 1400 of FIG. 14. Server 300 can be implemented in connection with server 600 of FIG. 6.

According to various embodiments, server 300 implements first server 110 of system 100 of FIG. 1.

Server 300 comprises verification module 310, packaging module 320, storage module 330, and publishing module 340. Server 300 can comprise additional modules or can exclude certain of the aforementioned modules. For example, verification module 310 and publishing module 340 can serve as optional modules. Server 300 can communicate with one or more other servers or devices over a network such as network 150 of system 100 of FIG. 1. For example, server 300 obtains information, such as an application development kit, from a database (e.g., database 160 of system 100 of FIG. 1). Server 300 can query database 160 for such information.

Verification module 310 can be configured to check application development kits. For example, verification module 310 can perform identity validity checks or data integrity checks or identity validity checks and data integrity checks. As an example, the developer certificate is an encrypted digital certificate and the developer identification is validated by verifying the certificate. As another example, the files in the packages are processed and corresponding md5 files are computed and saved in a file (e.g., an XML, file). The integrity checks can be recomputed and md5 values for files in the packages can be compared with the md5 values saved in the file (e.g., in the XML file). Packaging module 320 is configured to obtain one or more application components from an application development kit. For example, packaging module 320 can obtain the application component resources included in the application development kit. Packaging module 320 can package the obtained application component resources to obtain an application resource kit. The unit of resource organization of the application resource kit is an application component. Storage module 330 is configured to establish an index for the application resource kits and to store the application resource kits. Publishing module 340 is configured to publish the corresponding application resource kits.

In some embodiments, server 300 communicates the application resource kit to a remote repository. For example, server 300 can communicate the application resource kit to database 360. Server 300 can communicate the application resource kit via a network.

FIG. 4 is a flowchart of a method for application resource management according to various embodiments of the present disclosure.

Referring to FIG. 4, process 400 for application resource management is provided. Process 400 can be implemented by system 100 of FIG. 1, server 300 of FIG. 3, and/or computer system 1400 of FIG. 14. Process 400 can be implemented in connection with application development kit directory 200 of FIG. 2, user interface 1100 of FIG. 11, user interface 1200 of FIG. 12, and/or user interface 1300 of FIG. 13. Process 400 can be implemented in connection with process 700 of FIG. 7, process 800 of FIG. 8, and/or process 900 of FIG. 9. At least part of process 400 can be implemented by server 300 of FIG. 3, device 500 of FIG. 5, and/or server 600 of FIG. 6.

At 410, an application development kit is obtained. In some embodiments, a server obtains the application development kit. The server can correspond to first server 110 of system 100 of FIG. 1, and/or server 300 of FIG. 3. The server can obtain the application development kit from a client terminal. For example, the server can obtain the application development kit from client device 130 of system 100 of FIG. 1. The client terminal can send the application development kit to the server. The application development kit can comprise the relevant resources of one or more application components. As an example, the directory structure of the application development kit can correspond to application development kit directory 200 of FIG. 2.

At 420, the application development kit is analyzed to determine whether the application development kit satisfies one or more criteria. As an example, a server analyzes the application development kit. The server can correspond to server 300 of FIG. 3, and/or first server 110 of system 100 of FIG. 1. The application development kit can be analyzed to determine whether the application development kit satisfies a verification of the developer identification (e.g., a developer certificate is verified), and/or a verification of the data integrity of the application development kit (e.g., a data integrity check is performed).

The one or more criteria to which the application development kit can be associated with are validity of identity, data integrity, etc. For example, the application development kit can be analyzed to determine whether the application development kit satisfies one or more criteria with respect to the identity validity of the application development kit and/or the data integrity of the application development kit. In some embodiments, a signature file comprised in the application development kit can be analyzed to verify the validity of the identity of the developer of the application development kit. In some embodiments, a check code comprised in (or that can be derived from) the application development kit can be analyzed to verify data integrity of the application development kit.

As an example in the context of server 300 of FIG. 3 or the first server 110 of system 100 of FIG. 1, the verification module 310 performs a check on the application development kit with regard to its identity validity and/or its data integrity. In connection with performing the data validity check, the verification module 310 can read the signature file comprised in the application development kit. Verification module 310 verifies the validity of the developer's identity on the basis of the developer identity information comprised in the signature file that is comprised in the application development kit.

The application development kit can comprise a check code for verifying data integrity. In an example, this check code can be obtained through integrity check algorithm calculations performed on the content of the application development kit. During a data integrity check, verification module 310 performs integrity check algorithm calculations on the content of the application development kit that was received and thus generates a check code. Verification module 310 compares the generated check code to the check code contained in the application development kit. If the check code and the generated check code are consistent, then data integrity has been successfully verified. Otherwise, if the check code and the generated check code are not consistent, then data integrity has failed to be verified. By performing an identity validity and/or data integrity check, the verification module 310 can ensure application development kit security (e.g., the verification module 310 can exclude malicious application resources).

If the application development kit is determined to not satisfy the one or more criteria at 420, then process 400 proceeds to 430 at which a result of the determination is provided. For example, in the event that the application development kit is determined to not satisfy the one or more criteria, the server communicates an indication to a terminal (e.g., the first client device). The indication can indicate that the application development kit is determined to not satisfy the one or more criteria. The server can report a result of checking the application development kit against the one or more criteria.

If the application development kit is determined to not satisfy the one or more criteria at 420, then process 400 proceeds to 430 at which a result of the determination is provided.

At 440, application component resources are obtained. In some embodiments, application component resources are comprised in the application development kit. The application component resources can be obtained based at least in part on the application development kit. For example, the application component resources can be obtained by analyzing the application development kit in connection with one or more application development kit packaging rules. The one or more application development kit packaging rules can be used in connection with extracting the application component resources from the application development kit. The server (e.g., first server 110 of system 100 of FIG. 1, and/or server 300 of FIG. 3) obtains the application component resource from the application development kit. The server can analyze the application development kit according to application development kit packaging rules in order to obtain configuration information comprised therein that is used to describe application components. The server obtains from the application development kit the resources of the application components described by this configuration information.

To take as examples the first server 300 of FIG. 3 and the application development kit directory structure described above, at 440, packaging module 320 analyzes the application development kit based at least in part on (e.g., using) the application development kit directory structure and thus obtains the application component configuration file comprised therein. In some embodiments, the application components declared in the application component configuration file serve as a basis for obtaining application resources relating to the application components under the directory corresponding to the application development kit. The application resources can comprise one or more of: program code files, data files, and files for describing dependency relationships, etc.

At 450, one or more application resource kits are obtained. In some embodiments, a server such as server 110 of system 100 of FIG. 1 or server 300 of FIG. 3 can obtain the application resource kits. The application resource kits can be obtained based at least in part on (e.g., using) the application component resources (e.g., that are obtained at 440 of process 400). The application resource kits can be obtained (e.g., generated) based at least in part on (e.g., by) packaging the application component resources. The application development kit can be generated by zipping the files to an archive and generating a developer certificate and/or integrity value for the archive.

In some embodiments, the unit of resource organization of the application resource kits is the application component. As an example, the application resource kit is comprised of one or more application components, and an application component functions as a basic unit of the resource organization. In some embodiments, signature information is associated with the application resource kit. For example, the server associates the signature information with the application resource kit. The signature resource information can be configured and comprised in the application resource kit. The signature information can be configured or used for describing or declaring the developer and owner of the application resource kit and the data signatures used thereby. Version information can be associated with the application resource kit. For example, the server can determine and/or associate signature information with the application resource kit. The version information can be included in the application resource kit.

Continuing to use the server 300 of FIG. 3 and the above-described application development kit directory structure as examples, packaging module 320 can package the Application Component A program code file, the bundle.json file, and the data resource files that are under the directory in which Application Component A is located and that were acquired at 440.

At 460, an index associated with the application resource kit is determined and stored. For example, the index can be established for the application resource kit. The server (e.g., first server 110 of system 100 of FIG. 1 and/or server 300 of FIG. 3) establishes an index for the application resource kits and stores the application resource kit in, for example, database 160. In some embodiments, a Uniform Resource Identifier (URI) is configured (e.g., determined) for the application resource kit. As another example, storage module 330 of server 300 determines the index associated with the application resource kit and/or stores the index associated with the application resource kit. A mapping of indices associated with application resource kits and application resource kits is stored (e.g., by database 160).

In some embodiments, the server can, with regard to each application development kit, establish two levels of indices for corresponding application resource kits (specifically including a first-level index and a second-level index) and establish mapping relationships between the two levels of indices. The first-level index of each application resource kit can be used in connection with describing the services provided by the corresponding application resource kit, and the second-level index of each application resource kit comprises a unique identifier, such as the URI associated with the corresponding application resource kit. As an example, the first-level index is generated with functions of the service provided by the application development kit and the second-level index is generated according to the component uniform resource identifier. As another example, the first-level index and the second-level index can use corresponding database technology to perform quick searching. The first-level index can describe the service content of the corresponding application resource kits. The first-level index corresponding to application resource kits can be expressed as content describing the services provided by the corresponding application resource kits. The first-level index provides the user an intuitive understanding of the services provided by, or functions implemented by, the applicable application resource kits. The second-level index is used in connection with an interaction between the client device and the server, and can be used to uniquely identify each application resource kit.

At 470, one or more application resource kits are published. In some embodiments, the server (e.g., server 110 of system 100 of FIG. 1, and/or server 300 of FIG. 3) publishes the one or more application resource kits. As an example, publishing module 340 of server 300 publishes the one or more application resource kits.

The server (e.g., first server 110 of system 100 of FIG. 1) can publish application resource kits in multiple ways. For example, the server can publish link information for application resource kits. The link information can be published in an application management center, other application management and publication application, etc. The display text corresponding to the link information is obtained based at least in part on the first-level index of the application resource kits, and the URIs relating to the link information are obtained with the second-level index of the application resource kits. Publishing link information for application resource kits can provide the user an intuitive understanding of the services provided by the application resource kits and can enable the user to obtain an application resource kit by clicking or through some other operation and thus obtain the service provided by, or the function implemented by, the application resource kit. As another example, the server (e.g., first server 110) can assign graphical identification codes (such as bar codes, QR codes, etc.) to application resource kits. The graphical identification code can be associated with the two levels of indices corresponding to the application resource kit. Graphical identification codes can be presented in locations at which such identification codes are accessible to users (e.g., application stores, a search bar, an advertising wall, etc.). Accordingly, the user can use a terminal (e.g., a client device) to scan a graphical identification code and thus obtain an application resource kit and in turn obtain the service provided by, or the function implemented by, the application resource kit.

In the above-described application resource management process 400 shown in FIG. 4, the execution sequence for operation of the various parts is merely an example. The present application imposes no restrictions in this regard.

According to various embodiments, application resources can be packaged and/or managed in units of application components. Such packaging and/or management of application resources provides a foundation for obtaining and using application resources in units of application components.

Various embodiments provide a process, device, and/or system for using application resources.

FIG. 5 is a structural diagram of a client device according to various embodiments of the present disclosure.

Referring to FIG. 5, device 500 is provided. Device 500 can be implemented in connection with system 100 of FIG. 1. Device 500 can be implemented in connection with application development kit directory 200 of FIG. 2, user interface 1100 of FIG. 11, user interface 1200 of FIG. 12, and/or user interface 1300 of FIG. 13. Device 500 can implement at least part of process 800 of FIG. 8, and/or process 900 of FIG. 9. Device 500 can be implemented in connection with process 400 of FIG. 4 and/or process 700 of FIG. 7. Device 500 can be implemented by computer system 1400 of FIG. 14. Device 500 can be implemented in connection with server 300 of FIG. 3 and/or server 600 of FIG. 6.

According to various embodiments, device 500 implements second client device 140 of system 100 of FIG. 1.

Device 500 (e.g., second device 140 of system 100 of FIG. 1) comprises runtime scheduling module (Runtime Scheduler) 510 and application management module 520. Device 500 can further comprise network management module 530. Runtime scheduling module 510, application management module 520, and/or network management module 530 can be function modules in an operating system of a terminal. Device 500 can comprise additional modules or can exclude certain of the aforementioned modules.

Runtime scheduling module 510 can be configured to send an application resource request. For example, runtime scheduling module 510 can send the application resource request to application management module 520. The application resource request can be used in connection with requesting an application resource kit. The application resource request can comprise an identifier associated with (e.g., that identifies) the application resource kit that is being requested (e.g., that corresponds to the application resource request). The unit of organization of the application resource kit (e.g., that is subject to the application resource request) is an application component. As an example application resource request can be sent in response to one or more runtime scheduling modules providing a sendlink API. The send link API can enable an application to send the application resource request. The application resource request can comprise a json string comprising key-value pairs. As an example, the application resource request can comprise device information, target service, timestamp, a target application component uniform resource identifier, a server address, etc.

Application management module 520 can be configured to obtain an application resource kit. As an example, the application resource kit can be obtained from a server (e.g., a server named ‘PageCenter’). The application management module 520 can request (or query) the server for the application resource kit. Application management module 520 can provide the obtained application resource kit to one or more other modules or devices. As an example, application management module 520 uses the application resource request as a basis for obtaining the application resource kit. In response to obtaining the application resource kit (e.g., that is associated with the application resource request), the acquired application resource kit is provided to runtime scheduling module 510. For example, the application management module 520 provides the corresponding application resource kit to the runtime scheduling module 510. In some embodiments, application management module 520 communicates a request for the application resource kit to a server. For example, application management module 520 can communicate a request for the application resource kit via a network. Application management module 520 can forward the application resource request to the server, or otherwise query the server for the corresponding application resource kit. In some embodiments, application management module 520 queries a database that stores application resource kits (or pointers such as location information corresponding to a location from which an application resource kit can be obtained or downloaded or otherwise obtained).

Runtime scheduling module 510 can be further configured to obtain the application resource kit corresponding to (e.g., responsive to) the application resource request. For example, runtime scheduling module 510 receives the application resource kit from application management module 520. In response to obtaining the application resource kit, runtime scheduling module 510 activates the application component in the application resource kit. As an example, the runtime schedule module provides an API to an application to enable the application to activate an application component directly on the operating system. The application component can be found and identified based on a uniform resource identifier. A runtime module can respond by activating the application component corresponding to the uniform resource identifier, and perform a starting, stopping, running, and other parts of runtime lifecycle management (e.g., with regard to the application component). The uniform resource identifier is unique for each application component. Accordingly, the runtime scheduling module can select the appropriate application component to activate if the application resource kit comprises a plurality of application components.

In some embodiments, application management module 520 uses the application resource request as a basis for looking up (e.g., searching for) a locally cached application resource kit stored on device 500 (e.g., the second client device 140 of system 100 of FIG. 1). If the locally cached application resources comprise the requested application resource kit, then the requested application resource kit is obtained (e.g., by application management module 520) from the cached application resource kits. If the locally cached application resources do not comprise the requested application resource kit, then the corresponding application resource kit can be requested (e.g., queried) from a network resource. For example, if the locally cached application resources do not comprise the requested application resource kit, then network management module 530 requests the requested application resource kit from a server (e.g., second server 120 of system 100 of FIG. 1). In some embodiments, network management module 530 requests the requested application resource kit from a database such as database 160 of system 100. Network management module 530 can request the requested application resource kit, or forward the application resource request, via a network.

Runtime scheduling module 510, application management module 520, network management module 530, or any combination thereof can be combined into one or more modules. For example, all or a part of functionality of any one or more modules can be combined into and performed by a single module, or a plurality of separate modules.

FIG. 6 is a structural diagram of a server according to various embodiments of the present disclosure.

Referring to FIG. 6, server 600 is provided. Server 600 can be implemented in connection with system 100 of FIG. 1. Server 600 can be implemented in connection with application development kit directory 200 of FIG. 2, user interface 1100 of FIG. 11, user interface 1200 of FIG. 12, and/or user interface 1300 of FIG. 13. Server 600 can implement at least part of process 400 of FIG. 4, process 700 of FIG. 7, process 800 of FIG. 8, and/or process 900 of FIG. 9. Server 600 can be implemented by computer system 1400 of FIG. 14. Server 600 can be implemented in connection with server 300 of FIG. 3.

According to various embodiments, server 600 implements second server 120 of system 100 of FIG. 1.

Server 600 comprises application management module 610 and network management module 620. Server 600 can comprise additional modules or can exclude certain of the aforementioned modules. Application management module 610, network management module 620, and/or other modules comprised in server 600 can correspond to function modules in an operating system of a terminal such as server 600.

Application management module 610 obtains a request for an application resource. The request for an application resource can be obtained from one or more terminals connected to server 600 via one or more networks. For example, application management module 610 can obtain the application resource request that is communicated by device 500. Application management module 610 can obtain the request for the application resource from network management module 620. Application management module 610 can use the received application resource request as a basis for looking up the requested application resource kit. In response to obtaining the requested application resource kit, application management module 610 can communicate the requested application resource kit to a terminal such as device 500 of FIG. 5 or second client device 140 of system 100 of FIG. 1. Application management module 610 can communicate the looked-up application resource kit (or pointers such as location information corresponding to a location from which an application resource kit can be obtained or downloaded or otherwise obtained) via the network management module 620 to device 500 of FIG. 5 and/or second client device 140 of system 100 of FIG. 1. In some embodiments, in response to receiving the request for the application resource, server 600 (e.g., via application management module 610) can query one or more databases for the application resource kit (or for pointers such as location information corresponding to a location from which an application resource kit can be obtained or downloaded or otherwise obtained).

Network management module 620 is configured to interface with one or more networks. For example, network management module 620 can provide network connectivity to server 600. In some embodiments, network management module 620 obtains the request for the application resource (e.g., from device 500 of FIG. 5), and/or communicates the corresponding application resource kit responsive to the request for the application resource to one or more terminals (e.g., device 500 of FIG. 5). Network management module 620 can provide connectivity to one or more remote repositories such as database 160 of system 100 of FIG. 1.

FIG. 7 is a flowchart of a method for using an application resource according to various embodiments of the present disclosure.

Referring to FIG. 7, process 700 for using one or more application resources is provided. Process 700 can be implemented by system 100 of FIG. 1, server 300 of FIG. 3, and/or computer system 1400 of FIG. 14. Process 700 can be implemented in connection with application development kit directory 200 of FIG. 2, user interface 1100 of FIG. 11, user interface 1200 of FIG. 12, and/or user interface 1300 of FIG. 13. Process 700 can be implemented in connection with process 400 of FIG. 4, process 800 of FIG. 8, and/or process 900 of FIG. 9. At least part of process 700 can be implemented by server 300 of FIG. 3, device 500 of FIG. 5, and/or server 600 of FIG. 6.

According to various embodiments, process 700 can be implemented, at least in part, by device 500 of FIG. 5 and/or server 600 of FIG. 6.

At 710, an application resource request is obtained. A terminal such as a client device can obtain the application resource request. For example, second client device 140 of system 100 of FIG. 1 receives an application resource request. As an example, the application resource request is invoked by an application that is attempting (e.g., to perform or execute) a certain functionality. As another example, the application resource request is invoked in response to a user request that triggers or selects certain functionality. The application resource request corresponds to a request for requesting an application resource kit. The unit of resource organization of the application resource request is an application component.

According to various embodiments, a terminal receives the application resource request based at least in part on a user input. For example, in response to a user inputting an input corresponding to an application resource request, the terminal can generate an application resource request. An example of such an input is a button displayed on a user interface for a user to request a specific application resource. In response to receiving selection of the button on the user interface, the terminal generates an application resource request for the specific application resource. Other inputs can be associated with invocation of an application resource request. For example, the input can be a selection of a predefined link, etc.

At 720, an application resource kit is obtained. A terminal can obtain the application resource kit based at least in part on the application resource request. For example, in response to obtaining the application resource request, a local cache or remote repository can be queried for an application resource kit corresponding to the application resource request. The application request can comprise, or otherwise be associated with, an identifier that identifies the application resource kit corresponding to the application resource request. The application resource kit can be obtained from a local cache at the terminal (e.g., second client device 140 of system 100 of FIG. 1). For example, the terminal queries (or searches for) a local cache for an application resource kit corresponding to the application resource request. The query for the application resource kit can be based on an identifier associated with the application resource kit, a functionality of the application resource kit, etc., or any combination thereof. The obtaining of the application resource kit can comprise retrieving the application resource kit from the local cache based on a result of the query of the local cache. As another example, the terminal queries a server or remote repository (e.g., database 160 of system 100 of FIG. 1) for the application resource kit. The terminal can communicate the application resource request to the server or remote repository. The terminal can receive the application resource kit in response to the query of the server or the remote repository. The terminal can also receive pointer(s) such as location information corresponding to a location from which an application resource kit can be obtained or downloaded or otherwise obtained. If the terminal receives pointer(s) such as location information corresponding to a location from which an application resource kit can be obtained or downloaded or otherwise obtained, the terminal can obtain (e.g., download) the application resource kit. The terminal can query the server or remote repository in the event that the terminal is unable to locate the application resource kit responsive to the application resource request locally. In some embodiments, the terminal gives priority to obtaining the requested application resource kit locally and obtains the application resource kit remotely (e.g., by querying a server or other remote repository) if the terminal is unable to locate the requested application resource kit locally.

At 730, one or more application components are activated. The one or more application components that are activated can be obtained from the application resource kit. In response to obtaining the application resource kit (e.g., in connection with the application resource request), the terminal, such as second client device 140 of system 100 of FIG. 1, activates the one or more application components. The terminal can parse the application resource kit and extract the one or more application components before activation of the one or more application components. In some embodiments, activation of the one or more application components comprises executing (e.g., running) the one or more application components. As an example, a requested function or service is performed based at least in part on the activation of the one or more application components. As an example, one or more application components are activated in response to user input and/or an application attempt to perform a certain functionality by invoking API to send a request to activate the one or more application component. After the request to activate the one or more application components, the application center (e.g., remote server) will find application component according to request and return the response with target application resource kit. After runtime module get the response and downloads the application resource kit, the runtime module will start the target application component and activate and display the application component. The lifecycle of the activated component will be managed by runtime module.

FIG. 8 is a flowchart of a method for using an application resource according to various embodiments of the present disclosure.

Referring to FIG. 8, process 800 for using one or more application resources is provided. Process 800 can be implemented by system 100 of FIG. 1, server 300 of FIG. 3, and/or computer system 1400 of FIG. 14. Process 800 can be implemented in connection with application development kit directory 200 of FIG. 2, user interface 1100 of FIG. 11, user interface 1200 of FIG. 12, and/or user interface 1300 of FIG. 13. Process 800 can be implemented in connection with process 400 of FIG. 4, process 700 of FIG. 7, and/or process 900 of FIG. 9. At least part of process 800 can be implemented by server 300 of FIG. 3, device 500 of FIG. 5, and/or server 600 of FIG. 6.

At 810, an application resource request is communicated. The terminal communicates the application resource request in response to an application component activating event. The application component activating event can correspond to obtaining a predefined input from a user (e.g., selection of a button associated with activation of an application component, selection of a link associated with activation of an application component, etc.). In some embodiments, in response to the application component activating event, the terminal generates the application resource request and communicates the application resource request. The terminal can correspond to second client device 140 of system 100 of FIG. 1. In some embodiments, the application resource request is communicated to the resource management module of the terminal. The application resource request can include an identifier for the corresponding application resource (e.g., the requested application resource kit), or the application resource request can otherwise be associated with an application resource kit.

Let us take as an example the structure of a client device such as device 500 of FIG. 5. At 810, in response to a user clicking on a link corresponding to an application resource kit or otherwise (by, for example, scanning a QR code) invokes device 500 to activate the corresponding application component, the operating system of device 500 notifies runtime scheduling module 510 of the relevant event generated by the user operation. Runtime scheduling module 510 sends a request to application management module 520 to request the application resource kit corresponding to the user-requested function. As an example, the URI for the application resource kit is included in the event received by the runtime scheduling module 510 and the URI for the application resource kit is included in the request sent by the runtime scheduling module 510 to application management module 520.

At 820, a local query is performed for the application resource kit. The query can be performed based at least in part on the application resource request. For example, an identifier associated with an application resource kit (e.g., the requested application resource kit) is obtained based at least in part on the application resource request, and the identifier associated with the application resource kit is used in connection with performing the query. The terminal can query a local cache to determine whether the local cache stores the application resource kit (or stores a location at which the application resource kit can be obtained).

Continuing with the example described above with regard to 810 of process 800, application management module 520 can attempt to find the application resource kit corresponding to the application resource request in a local storage. Application management module 520 searches a local cache for the application resource kit corresponding to the application resource request. Application management module 520 of device 500 searches among locally cached application resource kits for the requested application resource kit. If the requested application resource kit has already been cached locally, application management module 520 will send back the locally cached application resource kit corresponding to the application resource request to runtime scheduling module 510 of device 500.

At 830, a determination of whether the application resource kit is available locally is made. The terminal can determine whether the application resource kit corresponding to the application resource request (e.g., the requested application resource kit) is available locally. For example, the terminal determines whether the application resource kit is available locally based on the query for the application resource kit locally at 820.

If the application resource kit is determined to not be available locally at 830, then process 800 proceeds to 840 at which the application resource kit is obtained from a non-local source. The application resource kit can be obtained from a remote source such as server 600 of FIG. 6 or a database such as database 160 of system 100 of FIG. 1. In response to determining that the application resource kit is not available locally, the terminal can query a server. For example, the terminal requests the application resource kit corresponding to the application resource request from, or forwards the application request to, the server.

Continuing with the example described above with regard to 810 and 820 of process 800, if the application management module 520 is unable to obtain the application resource kit corresponding to the user-requested function from among the locally cached application resource kits, then application management module 520 issues via network management module 530 a remote procedure call (RPC), and sends an application resource request to the server (e.g., server 600 of FIG. 6) requesting an application resource kit corresponding to the user-requested function. After application management module 610 of the server 600 receives the request for the application resource kit corresponding to the user-requested function, server 600 uses the request application resource kit corresponding to the user-requested function as a basis for obtaining the corresponding application resource kit and sends back the obtained application resource kit via network management module 620 to application management module 520 of device 500. Furthermore, device 500 can also cache the application resource kit obtained from server 600 locally on the device 500.

The server can obtain the requested application resource kit locally or remotely. For example, the server can obtain the requested application resource kit from a local storage that is local to the server. As another example, the server can obtain the requested application resource kit from a remote storage such as a database (e.g., database 160 of system 100 of FIG. 1) that stores application resource kits. In some embodiments, the server obtains a pointer such as location information corresponding to a location from which an application resource kit can be obtained or downloaded or otherwise obtained.

In response to the server obtaining the application resource kit (or a pointer such as location information corresponding to a location from which an application resource kit can be obtained or downloaded or otherwise obtained), the server communicates the application resource kit (or the pointer such as location information corresponding to a location from which an application resource kit can be obtained or downloaded or otherwise obtained) to the terminal (e.g., from which the application resource request was communicated).

At 850, an application resource kit is obtained. If the application resource kit is determined to be available locally at 830, then process 800 proceeds to 850 at which the application resource kit is obtained locally. In contrast, if the application resource kit is determined to not be available locally at 830, then the application resource kit is obtained from the network resource such as via the server if the server obtained the application resource kit at 840. The application resource kit can be communicated to runtime scheduling module 510 of device 500. For example, in response to obtaining the application resource kit, application management module 520 communicates the application resource kit to runtime scheduling module 510.

At 860, an application resource kit is activated. The application resource kit that is obtained in connection with the application resource request is activated. For example, the terminal activates the application resource kit. As an example, the application resource kit is activated in response to user input and/or an application attempt to perform a certain functionality by invoking API to send a request to activate the application resource kit.

Continuing with the example described above with regard to 810, 820, and 840 of process 800, after runtime scheduling module 510 of device 500 (e.g., the second client device 140 of system 100) obtains an application resource kit, the application component in the application resource kit is activated. Thus, the requested function is activated for the user, or the corresponding service is provided.

FIG. 9 is a flowchart of a method for using an application resource according to various embodiments of the present disclosure.

Referring to FIG. 9, process 900 for using one or more application resources is provided. Process 900 can be implemented by system 100 of FIG. 1, server 300 of FIG. 3, and/or computer system 1400 of FIG. 14. Process 900 can be implemented in connection with application development kit directory 200 of FIG. 2, user interface 1100 of FIG. 11, user interface 1200 of FIG. 12, and/or user interface 1300 of FIG. 13. Process 900 can be implemented in connection with process 400 of FIG. 4, process 700 of FIG. 7, and/or process 800 of FIG. 8. At least part of process 900 can be implemented by server 300 of FIG. 3, device 500 of FIG. 5, and/or server 600 of FIG. 6.

At 905, an activating application component event is obtained. The application component activating event can correspond to obtaining a predefined input from a user (e.g., selection of a button associated with activation of an application component, selection of a link associated with activation of an application component, etc.).

At 910, an application resource request is communicated. The application resource request is communicated by a runtime scheduling module of a terminal to an application management module of the terminal. In some embodiments, in response to the application component activating event, the terminal generates the application resource request and communicates the application resource request using RPC or other appropriate protocol.

As an example, in response to a user clicking on a link corresponding to an application resource kit or otherwise activating the corresponding application component, the operating system of the terminal sends a message to the runtime scheduling module.

At 915, a local application resource kit is requested. For example, the terminal determines whether the application resource kit corresponding to (e.g., responsive to) the application resource request is available locally (e.g., stored locally at the terminal).

If the application resource kit is available locally (e.g., locally cached), then at 920, the corresponding application resource kit is communicated. For example, the application management module communicates the application resource kit to the runtime scheduling module.

In contrast, if the application resource kit is not available locally, then at 925, an application resource request is communicated. For example, the application resource request can be communicated from the application management module of the terminal to the network management module of the terminal. In some embodiments, the application management module forwards the application resource request obtained at 910 to the network management module. In some embodiments, the application management module generates a request for the application resource based at least in part on the application resource request obtained at 910.

At 930, the application resource request is communicated to a remote terminal. For example, the application resource request is communicated to a server. The network management module of the terminal can communicate the application resource request of the server. The application resource request can be communicated over one or more networks. The one or more networks can include the Internet, a wide area network, a local area network, etc. The application resource request communicated between the terminal and the server can be configured according to a protocol by which the terminal and the server communicate, etc. As an example application resource request can be sent in response to one or more runtime scheduling modules providing a sendlink API. The send link API can enable an application or terminal to send the application resource request. The application resource request can comprise a json string comprising key-value pairs. As an example, the application resource request can comprise device information, target service, timestamp, a target application component uniform resource identifier, a server address, etc. The protocol for communication between the terminal and the server can be self-defined and can be based on Hypertext Transfer Protocol (HTTP) or HTTP Secure.

At 935, the application resource request is communicated from the network management of the server to the application management module of the server.

At 940, a remote application resource kit is obtained. For example, the server obtains the application resource kit from a storage that is remote with respect to the terminal. The server obtains the application resource kit from a storage that is local to the server or that is remote to the server. In some embodiments, the server queries one or more remote storages or databases for the application resource kit. The server can perform the query based at least in part on the application resource request. For example, the server can obtain an identifier associated with a requested application resource kit, etc., and generate the query based on the identifier associated with the requested application resource kit. In some embodiments, the application management module of the server obtains the application resource kit.

At 945, an application resource kit is communicated. In response to obtaining the application resource kit from a storage that is remote with respect to the terminal, the application resource kit (e.g., the application resource kit responsive to the application resource request) can be prepared for communication to the terminal. The application management module of the server communicates the application resource kit to the network management module of the server.

At 950, the application resource kit is communicated to a remote terminal. For example, the server communicates the application resource kit to the terminal (e.g., from which the application resource request is received, such as the client device). The network management module of the server can communicate the application resource request of the terminal. The application resource kit can be communicated over one or more networks. The application resource kit communicated between the terminal and the server can be configured according to a protocol by which the terminal and the server communicate, etc.

At 955, the application resource kit is communicated from the network management module of the terminal to the application management module of the terminal. The application management module of the terminal can store the application resource kit locally (e.g., in a cache for application resource kits).

At 960, the application resource kit is communicated from the application management module of the terminal to the runtime scheduling module of the terminal. The runtime scheduling module can cause one or more application components comprised in the application resource kit to be activated.

According to various embodiments, application resources are acquired and used on the basis of application resource kits whereby the unit of resource organization of the application kits is the application component. User-requested functions are thus implemented, and application resources are loaded according to user need, without the user installing application resources on a client device. The loading of the application resources without requiring installation thereof conserves client device memory and disk space.

In some embodiments, if the requested application resource kit has been locally cached on a client device, the client device (or, more specifically, the application management module in the client device) can determine whether the application resource kit has an updated version. If the application resource kit has an associated updated version, then the updated version of the application resource kit is requested from a server, and the updated version of the application resource kit is cached locally on the client device. As an example, the following method might be adopted to determine whether locally cached application resources have updated versions: obtain version information for the locally cached application resources, and send a query request to a server requesting lookup of version information for the application resource kit; and compare the version information for the application resource kit returned by the server to the version information for the application resource kit cached locally in connection with determining whether the locally cached application resource kit has an updated version.

Through the process described above, updating application resources locally cached on a client device can be founded on the to-be-loaded application resource kit whereby the application component is the unit of resource organization, with granularity defined in terms of application resource kits. In this way, application upgrade efficiency is improved, and network resource expenditures can be reduced.

To further improve application upgrade efficiency so as to reduce network resource expenditures, locally cached application resources can be updated using a granularity that is even smaller than an application resource kit. Specifically, if the application resource kits locally cached on the client device comprise the requested application resource kit, then, with regard to the cached application resource kit, a determination can be made as to whether files in the application resource kit have updated versions. If files in the application resource kit do have updated versions, then the updated version files in this application resource kit are requested from the server, and the acquired updated version files are used to update the corresponding files in the cached application resource kit. As stated above, the application resource kit can include application component program code files and resource files (e.g., files for describing dependency relationships and picture files) used by the application components. Therefore, using this method, updating application resources with a resource granularity defined in terms of the files in the application resource kit is possible.

FIG. 10A is a diagram of updating an application resource according to various embodiments of the present disclosure. FIG. 10B is a diagram of updating an application resource according to various embodiments of the present disclosure.

FIG. 10A and FIG. 10B are comparative diagrams that present, for the purpose of providing an example, application resource updating according to application resource kit-sized granularity and resource updating according to granularity defined in terms of the files in the application resource kit. If the terminal (e.g., the client device) does not have the requested (e.g., by the user) application resource kit locally cached, the terminal (e.g., the client device) acquires the application resource kit “Page” from a server and caches all the contents of this application resource kit (e.g., all the files included in this application resource kit) locally on the terminal (e.g., the client device), as shown in FIG. 10A (1000). Each small square in FIG. 10A represents a component part having the minimum resource granularity (e.g., file granularity). For example, application component program code files, files for describing dependency relationships of application components, picture files used by application components, and other such files may be included. The file R shown in the figure is a file in Page 1. The file R may be a component part having the minimum resource granularity. For example, file R can be an application component program code file, a file for describing dependency relationships of application components, a picture file used by application components, or another such file. As illustrated in FIG. 10A, application resource kit 1000 comprises application components that are shown as the squares within application resource kit 1000. Application kit 1000 resides on a server (e.g., a remote server) and can be downloaded to a local cache (of the terminal).

If, subsequently, the user again requests this application resource kit, the terminal (e.g., the client device) will have already locally cached this application resource kit. Thus, the terminal (e.g., the client device) may further determine whether the files included in this application resource kit have updated versions. The terminal can determine whether the files included in the application resource kit have updated versions based on a version code (e.g., in the manifest file) of the application resource kit. If the file R has an updated version, then the terminal (e.g., the client device) obtains file R's updated version, which is file R′, from the server and uses file R′ to update the file R in the cached application resource kit, as shown in FIG. 10B (1050). As illustrated in FIG. 10B, application resource kit 1050 comprises application components that are shown as the squares within application resource kit 1000. Application kit 1000 resides on a server (e.g., a remote server) and can be downloaded to a local cache (of the terminal).

During actual application, application resource updating methods suitable for different scenarios may be selected. To give an example, when network performance is relatively good or network connections are done through WiFi, an application resource updating method that has application resource kit-sized resource granularity can be employed. Otherwise, an application resource updating method whose resource granularity is defined in terms of the files in the application resource kit can be employed. Various other contextual rules can be implemented in connection with determining the resource granularity with which to update an application resource kit.

For a clearer understanding of embodiments of the present application, embodiments are explained below in light of specific application scenarios.

FIG. 10C is a diagram of a method for updating an application resource according to various embodiments of the present disclosure.

Referring to FIG. 10C, process 1060 for application resource management is provided. Process 1060 can be implemented by system 100 of FIG. 1, server 300 of FIG. 3, and/or computer system 1400 of FIG. 14. Process 1060 can be implemented in connection with application development kit directory 200 of FIG. 2, application resource kit 1000 of FIG. 10A, application resource kit 1050 of FIG. 10B, user interface 1100 of FIG. 11, user interface 1200 of FIG. 12, and/or user interface 1300 of FIG. 13. Process 1060 can be implemented in connection with process 400 of FIG. 4, process 700 of FIG. 7, process 800 of FIG. 8, and/or process 900 of FIG. 9. At least part of process 400 can be implemented by server 300 of FIG. 3, device 500 of FIG. 5, and/or server 600 of FIG. 6.

At 1062, the terminal requests an application resource kit (Page). The terminal can request the application resource kit (Page) from the server. The terminal can request the application resource kit (Page) in response to a user selecting or triggering a certain functionality, or in response to an application attempting to execute or call certain functionality. The terminal can first attempt to locate the corresponding application resource kit (Page) from a local cache. If the terminal (e.g., the client device) does not have the requested (e.g., by the user) application resource kit locally cached, the terminal (e.g., the client device) request the application resource kit “Page” from a server and caches all the contents of this application resource kit (e.g., all the files included in this application resource kit) locally on the terminal (e.g., the client device).

At 1064, the terminal obtains the application resource kit (Page). The application resource kit (Page) can be communicated to the terminal from a server (e.g., over one or more networks). In response to obtaining the application resource kit (Page) from the server, the terminal stores the application resource kit (Page) in the local cache of the terminal.

At 1066, the terminal requests an updated resource (R′) for the application resource kit. The updated resource can be a file. The terminal can obtain the updated resource from the server. The terminal can request the updated resource (R′) in response to the terminal (e.g., the client device) determining that the files included in this application resource kit have updated versions. For example, in response to the application resource kit being subsequently requested (e.g., invoked) such as in response to a user request or triggering or in response to an application calling the application resource kit, the terminal can determine whether files included in this application resource kit have updated versions. The terminal can determine whether the files included in the application resource kit that is locally cached have an updated version based on a version identifier associated with the application resource kit and a version identifier associated with the application resource kit on the server. In some embodiments, the terminal queries the server for an indication of whether the server stores an updated application resource kit.

At 1068, the terminal obtains an updated resource (R′). The updated resource (R′) can be communicated to the terminal from a server (e.g., over one or more networks). In response to obtaining the updated resource from the server, the terminal stores the updated resource in the local cache of the terminal. For example, the terminal can replace the resource in the locally cached application resource kit with the corresponding updated resource.

FIG. 11 is a diagram of a User Interface (UI) of application components according to various embodiments of the present disclosure. FIG. 12 is a diagram of a UI of application components according to various embodiments of the present disclosure. FIG. 13 is a diagram of a UI of application components according to various embodiments of the present disclosure.

Referring to FIG. 11, UI 1100 is provided. Referring to FIG. 12, UI 1200 is provided. Referring to FIG. 13, UI 1300 is provided. UI 1100, UI 1200, and/or UI 1300 can be implemented in connection with application development kit directory 200 of FIG. 2. UI 1100, UI 1200, and/or UI 1300 can implement at least part of process 400 of FIG. 4, process 700 of FIG. 7, process 800 of FIG. 8, and/or process 900 of FIG. 9. At least part of UI 1100, UI 1200, and/or UI 1300 can be implemented by system 100 of FIG. 1, server 300 of FIG. 3, device 500 of FIG. 5, server 600 of FIG. 6, and/or computer system 1400 of FIG. 14.

Examples of application resource kits provided by the server can correspond to the following:

Application Resource Kit 1: for implementing the airplane ticket query function. The version is 1.0. The server sets up a QR code for Application Resource Kit 1. The QR code encodes the URI of Application Resource Kit 1. Application Resource Kit 1 includes the following files (filenames shown below for the purpose of providing examples):

search: an application component (called “search component”) program code file for implementing the airplane ticket query function; and

page1_picture: a picture file used by the search component.

Application Resource Kit 2: for implementing the airplane ticket order function. The version is 1.0. Application Resource Kit 2 includes the following files (filenames shown below for the purpose of providing examples):

order: an application component (called “order component”) program code file for implementing the airplane ticket order function;

page2_picture: a picture file used by the order component; and

dependency: describes the dependency relationship between the order component and an application component (called “payment component”) for implementing online payments. While running, the order component calls the payment component.

Application Resource Kit 3: for implementing online payment functions. The version is 2.0. Application Resource Kit 3 includes the following files (filenames shown below for the purpose of providing examples):

payment: program code file for implementing the payment component.

On the basis of the application resource kits described above, the user can implement airplane ticket query and order functions. An example of a process for implementing airplane ticket query and order functions is as follows:

The user uses a mobile terminal to scan a QR code corresponding to the Application Resource Kit 1 and obtains the URI for Application Resource Kit 1. Because the mobile terminal has not locally cached Application Resource Kit 1, the mobile terminal sends an application resource request to the server. The application resource request includes the URI for Application Resource Kit 1. The server uses the request as a basis for acquiring Application Resource Kit 1. For example, the server uses the URI for Application Resource Kit 1 to query (e.g., search for) the Application Resource Kit 1. The server sends Application Resource Kit 1 to the mobile terminal. The mobile terminal caches Application Resource Kit 1 locally and activates and runs the search component in Application Resource Kit 1. If the search component is activated, a user interface is displayed on the mobile terminal. For example, the UI 1100 of FIG. 1 can be presented on the mobile terminal screen. UI 1100 can correspond to a user interface of the search component. As illustrated in FIG. 11, UI 1100 includes a set of airplane ticket query condition input boxes 1110 and a query function button 1120. “page1_picture” in Application Resource Kit 1 is also presented on UI 1100.

The user inputs the airplane query conditions via the search component UI and clicks the query function key. For example, the user can input one or more query conditions into query condition input box 1110 and select the query function button 1120 to initiate a search. Referring to FIG. 12, query condition input box 1210 can correspond to query condition input box 1110 of FIG. 11, and query function button 1220 can correspond to query function button 1120 of FIG. 11. With the logic being executed on the basis of the search component, the mobile terminal sends the airplane ticket query request to the server and receives the airplane ticket query results sent back by the server. The mobile terminal displays the airplane ticket query results. For example, the mobile terminal can display UI 1200 that includes the airplane ticket query results and an order function button 1230 (e.g., airplane ticket order button). As an example, in response to selection of the order function button 1230, a request to order a selected airline ticket can be communicated to a server.

The user selects from the query results the airplane ticket that the user wishes to order and clicks on the order function button 1230. Selection of the order function key triggers the mobile terminal to use the application resource kit URI related to order function button 1230 as a basis for acquiring Application Resource Kit 2, which is configured to implement the airplane ticket order function. Because the mobile terminal has not cached Application Resource Kit 2, the mobile terminal sends an application resource request to the server. The application resource request includes the URI for Application Resource Kit 2. The server uses the request as a basis for acquiring Application Resource Kit 2. For example, the server uses the URI for Application Resource Kit 2 to query (e.g., search for) the Application Resource Kit 2. The server sends Application Resource Kit 2 to the mobile terminal. The mobile terminal caches Application Resource Kit 2 locally and activates and runs the order component in Application Resource Kit 2. After the order component is activated, a user interface of the order component is presented on the mobile terminal screen. For example, UI 1300 of FIG. 13 can be presented on the mobile terminal screen. As illustrated in FIG. 13, UI 1300 comprises an order component. UI 1300 comprises information input box 1310 (e.g., a set of information input boxes) and online payment function button 1320. The user can input information to be submitted for the airplane ticket ordering process to UI 1300 (e.g., to the information input box 1310). UI 1300 also comprises “page2_picture” that is included in Application Resource Kit 2. As an example, in response to selection of the online payment function button 1320, a request to complete payment of the airline ticket can be communicated to a server.

The user inputs the order information via the order component UI and selects the online payment function button 1320. Based on a dependency relationship file used by the order component, the mobile terminal obtains the Application Resource Kit 3 for implementing online payment functions. For example, the dependency relationship file can be included in Application Resource Kit 2. The dependency relationship file can define a relationship between online payment function button 1320 and Application Resource Kit 3 that can be used in connection with implementing online payment functions. As an example, the mobile terminal can already have Application Resource Kit 3 locally cached. Application Resource Kit 3 that is locally cached by the mobile terminal can have a version number corresponding to 1.0. If the version number of the locally cached Application Resource Kit 3 is lower than a version number of a corresponding Application Resource Kit stored on a remote repository or server, the application resource kit can be updated. For example, if the version number for Application Resource Kit 3 stored on the server or a database accessible to the server is 2.0, the application resource kit that is locally cached on the mobile terminal can be updated. The mobile terminal can obtain Application Resource Kit 3 associated with a version number 2.0 from the server and use Application Resource Kit 3 associated with a version number 2.0 to update the locally cached Application Resource Kit 3 associated with a version number 1.0. The mobile terminal activates the payment component in the Application Resource Kit 3 (e.g., the updated Application Resource Kit 3). After the payment component is activated, the user conducts the online payment operation via the payment component UI and completes the airplane ticket order.

If, in the process described above, the user only needs to conduct an airplane ticket query and does not need to order a ticket, then all that is necessary is to obtain (e.g., from a local cache or a remote repository) Application Resource Kit 1 and then to run the search component therein. Obtaining and activating Application Resource Kit 2 or Application Resource Kit 3 is not necessary according to this example of only conducting an airplane ticket query. Accordingly, loading of the appropriate application components is achieved on the basis of user need.

In the example above, a first level index can be generated according to application meta information such as the airplane ticket. The second level index can be generated according to the airplane ticket page uniform resource identifier.

FIG. 14 is a functional diagram of a computer system updating, using, or managing application resources according to various embodiments of the present disclosure.

Referring to FIG. 14, system 1400 for updating, using, and/or managing application resources is provided. System 1400 can be implemented in connection with application development kit directory 200 of FIG. 2, user interface 1100 of FIG. 11, user interface 1200 of FIG. 12, and/or user interface 1300 of FIG. 13. System 1400 can implement at least part of process 400 of FIG. 4, process 700 of FIG. 7, process 800 of FIG. 8, and/or process 900 of FIG. 9. At least part of system 1400 can be implemented by system 100 of FIG. 1, server 300 of FIG. 3, device 500 of FIG. 5, and/or server 600 of FIG. 6.

Computer system 1400, which includes various subsystems as described below, includes at least one microprocessor subsystem (also referred to as a processor or a central processing unit (CPU)) 1402. For example, processor 1402 can be implemented by a single-chip processor or by multiple processors. In some embodiments, processor 1402 is a general purpose digital processor that controls the operation of the computer system 1400. Using instructions retrieved from memory 1410, the processor 1402 controls the reception and manipulation of input data, and the output and display of data on output devices (e.g., display 1418).

Processor 1402 is coupled bi-directionally with memory 1410, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 1402. Also as is well known in the art, primary storage typically includes basic operating instructions, program code, data, and objects used by the processor 1402 to perform its functions (e.g., programmed instructions). For example, memory 1410 can include any suitable computer-readable storage media, described below, depending on whether, for example, data access needs to be bi-directional or uni-directional. For example, processor 1402 can also directly and very rapidly retrieve and store frequently needed data in a cache memory (not shown). The memory can be a non-transitory computer-readable storage medium.

A removable mass storage device 1412 provides additional data storage capacity for the computer system 1400, and is coupled either bi-directionally (read/write) or uni-directionally (read only) to processor 1402. For example, storage 1412 can also include computer-readable media such as magnetic tape, flash memory, PC-CARDS, portable mass storage devices, holographic storage devices, and other storage devices. A fixed mass storage 1420 can also, for example, provide additional data storage capacity. The most common example of mass storage 1420 is a hard disk drive. Mass storage device 1412 and fixed mass storage 1420 generally store additional programming instructions, data, and the like that typically are not in active use by the processor 1402. It will be appreciated that the information retained within mass storage device 1412 and fixed mass storage 1420 can be incorporated, if needed, in standard fashion as part of memory 1410 (e.g., RAM) as virtual memory.

In addition to providing processor 1402 access to storage subsystems, bus 1414 can also be used to provide access to other subsystems and devices. As shown, these can include a display monitor 1418, a network interface 1416, a keyboard 1404, and a pointing device 1406, as well as an auxiliary input/output device interface, a sound card, speakers, and other subsystems as needed. For example, the pointing device 1406 can be a mouse, stylus, track ball, or tablet, and is useful for interacting with a graphical user interface.

The network interface 1416 allows processor 1402 to be coupled to another computer, computer network, or telecommunications network using a network connection as shown. For example, through the network interface 1416, the processor 1402 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 1402 can be used to connect the computer system 1400 to an external network and transfer data according to standard protocols. For example, various process embodiments disclosed herein can be executed on processor 1402, or can be performed across a network such as the Internet, intranet networks, or local area networks, in conjunction with a remote processor that shares a portion of the processing. Additional mass storage devices (not shown) can also be connected to processor 1402 through network interface 1416.

An auxiliary I/O device interface (not shown) can be used in conjunction with computer system 1400. The auxiliary I/O device interface can include general and customized interfaces that allow the processor 1402 to send and, more typically, receive data from other devices such as microphones, touch-sensitive displays, transducer card readers, tape readers, voice or handwriting recognizers, biometrics readers, cameras, portable mass storage devices, and other computers.

The computer system shown in FIG. 14 is but an example of a computer system suitable for use with the various embodiments disclosed herein. Other computer systems suitable for such use can include additional or fewer subsystems. In addition, bus 1414 is illustrative of any interconnection scheme serving to link the subsystems. Other computer architectures having different configurations of subsystems can also be utilized.

It should be understood that the devices and methods that are disclosed in the several embodiments provided above can be realized in other ways. For example, the device embodiment described above is merely illustrative. For example, the delineation of units is merely a delineation according to local function. The delineation can take a different form during actual implementation.

A module described herein can also be referred to as a unit.

The units described as separate components may or may not be physically separate, and components displayed as units may or may not be physical units. They can be located in one place, or they can be distributed across multiple network units. The embodiment schemes of the present embodiments can be realized by selecting part or all of the units in accordance with actual need.

Furthermore, the functional units in the various embodiments of the present invention can be integrated into one processing unit, or each unit can have an independent physical existence, or two or more units can be integrated into a single unit. The aforesaid integrated units can take the form of hardware, or they can take the form of hardware combined with software function units.

The units described above in which the software function units are integrated can be stored in a computer-readable storage medium. The software function units described above are stored in a storage medium and include a number of commands whose purpose is to cause a piece of computer equipment (which can be a personal computer, a server, or network computer) or a processor to execute some of the steps in the method described in the various embodiments of the present invention. The storage medium described above encompasses: USB flash drive, mobile hard drive, read-only memory (ROM), random access memory (RAM), magnetic disk, or optical disk, or various other media that can store program code.

Each of the embodiments contained in this description is described in a progressive manner, the explanation of each embodiment focuses on areas of difference from the other embodiments, and the descriptions thereof may be mutually referenced for portions of each embodiment that are identical or similar.

The embodiments of the present application are described with reference to flowcharts and/or block diagrams based on methods, terminal devices (systems), and computer program products of the embodiments of the present application. Please note that each flowchart and/or block diagram within the flowcharts and/or block diagrams and combinations of flowcharts and/or block diagrams within the flowcharts and/or block diagrams can be realized by computer instructions. These computer program instructions can be provided to the processors of general-purpose computers, specialized computers, embedded processor devices, or other programmable data-processing terminals to produce a machine. The instructions executed by the processors of the computers or other programmable data-processing terminal devices consequently give rise to means for implementing the functions specified in one or more processes in the flowcharts and/or one or more blocks in the block diagrams.

These computer program instructions can also be stored in computer-readable memory that can guide the computers or other programmable data-processing terminal devices to operate in a specific manner. As a result, the instructions stored in the computer-readable memory give rise to products including instruction means. These instruction means implement the functions specified in one or more processes in the flowcharts and/or one or more blocks in the block diagrams.

These computer program instructions can also be loaded onto computers or other programmable data-processing terminal devices and made to execute a series of steps on the computers or other programmable data-processing terminal devices so as to give rise to computer-implemented processing. The instructions executed on the computers or other programmable data-processing terminal devices thereby provide the steps of the functions specified in one or more processes in the flowcharts and/or one or more blocks in the block diagrams.

Although preferred embodiments of the present application have already been described, persons skilled in the art can make other modifications or revisions to these embodiments once they grasp the basic creative concept. Therefore, the attached claims are to be interpreted as including the preferred embodiments as well as all modifications and revisions falling within the scope of the embodiments of the present application.

Lastly, it must also be explained that, in this document, relational terms such as “first” or “second” are used only to differentiate between one entity or operation and another entity or operation, without necessitating or implying that there is any such actual relationship or sequence between these entities or operations. Moreover, the term “comprise” or “contain” or any of their variants are to be taken in their non-exclusive sense. Thus, processes, methods, things, or terminal devices that comprise a series of elements not only comprise those elements, but also comprise other elements that have not been explicitly listed or elements that are intrinsic to such processes, methods, things, or terminal devices. In the absence of further limitations, elements that are limited by the phrase “comprises a(n) . . . ” do not exclude the existence of additional identical elements in processes, methods, things, or terminal devices that comprise said elements.

An embodiment of the present application further provides one or more computer-readable media. Said readable media stores instructions. According to various embodiments, upon being executed by one or more processors, said instructions cause the communication device to execute the methods implemented by the first server.

An embodiment of the present application further provides one or more computer-readable media. Said readable media stores instructions. Upon being executed by one or more processors, said instructions cause the communication device to execute the methods implemented by the second client device in embodiments of the present application.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
obtaining, by one or more processors, an application development kit, wherein the application development kit comprises resources for one or more application components;
obtaining, by the one or more processors, the resources for at least one of the one or more application component resources included in the application development kit;
packaging, by the one or more processors, at least one or more application component resources organization to obtain one or more application resource kits, wherein a unit of resources for the one or more application resource kits is the one or more application components; and
providing the one or more application resource kits to a client device in response to obtaining a request for the one or more application resource kits, wherein the client device obtains the one or more application components in the one or more application resource kits and activates the one or more application components in response to a request to perform a function is associated with the one or more application components.

2. The method of claim 1, wherein the resources for the one or more application components comprise one or both of the following:
application component program code; and
resource files used by the one or more application components.

3. The method of claim 2, wherein the resources used by the one or more application components comprise one or both of the following:
files for describing one or more dependency relationships between at least two of the one or more application components; and
data resource files used by at least one of the one or more application components.

4. The method of claim 1, further comprising:
establishing, by the one or more processors, an index for the one or more application resource kits; and
storing the one or more application resource kits.

5. The method of claim 4, wherein the establishing the index for the one or more application resource kits comprises:
establishing for at least one of the one or more application resource kits a first-level index and a second-level index and a mapping relationship between the first-level index and the second-level index, the first-level index of the at least one of the one or more application resource kits used in connection with describing services provided by the at least one of the one or more application resource kits, and the second-level index of the at least one of the one or more application resource kits comprising a unique identifier corresponding to the at least one of the one or more application resource kits.

6. The method claim 5, further comprising:
publishing link information for the one or more application resource kits, wherein display text of the link information is obtained from the first-level index of the corresponding one or more application resource kits, and a Uniform Resource Identifier (URI) corresponding to the link information is obtained based at least in part on the second-level index of the one or more is application resource kits.

7. The method of claim 5, further comprising:
associating one or more graphical identification codes with the one or more application resource kits, the one or more graphical identification codes associated with the one or more application resource kits being based at least in part on to the corresponding first-level index and the second-level index respectively associated with the one or more application resource kits.

8. The method of claim 5, wherein the first-level index comprises text, and the second-level index comprises one or more Uniform Resource Identifiers (URIs).

9. The method of claim 1, wherein the application development kit comprises configuration information for describing at least one of the one or more application components; and
obtaining the resources for at least one of the one or more application component resources comprised in the application development kit comprises:
obtaining the resources for the at least one of the one or more application components from the application development kit based at least in part on the configuration information corresponding to the at least one of the one or more application components.

10. The method of claim 1, wherein the one or more application components correspond to application components in a cloud operating system.

11. A method, comprising:
obtaining, by one or more processors, an application resource request;
obtaining, by the one or more processors, one or more requested application resource kits associated with the application resource request, wherein a unit of resource organization for the one or more application resource kits is one or more application components; and
running, by the one or more processors, the one or more applications component in the one or more application resource kits.

12. The method of claim 11, wherein obtaining the requested application resource kit associated with the application resource request comprises:
looking up a cached application resource kit based at least in part on the application resource request;
in response to cached application resources comprising the requested application resource is kit, obtaining the requested application resource kit from the cached application resource kit; and
in response to determining the cached application resources do not comprise the requested application resource kit, requesting the requested application resource kit from a server.

13. The method of claim 12, wherein in response to the cached application resources comprising the requested application resource kit, the method further comprises:
determining whether the requested application resource kit among the cached application resources has an updated version; and
in response to determining that the requested application resource kit among the cached application resources has an updated version, requesting the updated version of the requested application resource kit from the server and using an obtained updated version of the application resource kit to update the corresponding cached application resource kit.

14. The method of claim 11, wherein the requested application resource kit comprises resources for one or more application components and one or more of:
application component program code files; and
resource files used by the application component.

15. The method of claim 14, wherein the resource files used by one or more application components in the application resource kit comprise one or any combination of the following:
files configured to describe dependency relationships between at least two of the one or more application components; and
data resource files used by the one or more application components.

16. A server, comprising:
one or more processors configured to:
obtain an application development kit, wherein the application development kit comprises resources for one or more application components;
obtain the resources for at least one of the one or more application component resources comprised in the application development kit;
package at least one or more application component resources to obtain one or more application resource kits, wherein a unit of resources organization for the one or is more application resource kits is the one or more application components; and
provide the one or more application resource kits to a client device in response to obtaining a request for the one or more application resource kits, wherein the client device obtains the one or more application components in the one or more application resource kits and activates the one or more application components in response to a request to perform a function associated with the one or more application components; and
one or more memories coupled to the one or more processors, configured to provide the one or more processors with instructions.

17. A computer program product, the computer program product being embodied in a non-transitory computer readable storage medium and comprising computer instructions for:
obtaining, by one or more processors, an application development kit, wherein the application development kit comprises resources for one or more application components;
obtaining, by the one or more processors, the resources for at least one of the one or more application component resources comprised in application development kit;
packaging, by the one or more processors, at least one or more application component resources to obtain one or more application resource kits, wherein a unit of resources organization for the one or more application resource kits is the one or more application components; and
providing the one or more application resource kits to a client device in response to obtaining a request for the one or more application resource kits, wherein the client device obtains the one or more application components in the one or more application resource kits and activates the one or more application components in response to a request to perform a function associated with the one or more application components.

18. A client device, comprising:
one or more processors configured to:
obtain an application resource request;
obtain one or more requested application resource kits associated with the application resource request, wherein a unit of resource organization for the one or more is application resource kits is one or more application components; and
run the one or more application components in the one or more application resource kits; and
one or more memories coupled to the one or more processors, configured to provide the one or more processors with instructions.

19. A computer program product, the computer program product being embodied in a non-transitory computer readable storage medium and comprising computer instructions for:
obtaining, by one or more processors, an application resource request;
obtaining, by the one or more processors, one or more requested application resource kits associated with the application resource request, wherein a unit of resource organization for the one or more application resource kits is one or more application components; and
running, by the one or more processors, the one or more application components in the one or more application resource kits.
